(19) United States
(12) Patent Application Publication
(10) Pub. No.: US 2025/0016793 A1
(43) Pub. Date: Jan. 9, 2025

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Naoya Shibalke, Tokyo (JP); Satoshi Nagata, Tokyo (JP)

(73) Assignee: NTT DOCOMO, INC., Tokyo (JP)

(21) Appl. No.: 18/708,121

(22) PCT Filed: Nov. 10, 2022
(86) PCT No.: PCT/JP2022/041874

§ 371 Date: May 7, 2024

(30) Foreign Application Priority Data
Nov. 11, 2021 (JP) 2021-184362

(51) Int. Cl. H04W 72/231; H04L 5/00; H04W 76/20

(52) U.S. Cl. CPC H04W 72/231; H04L 5/0051; H04W 76/20

(57) ABSTRACT

A terminal according to one aspect of the present disclosure includes: a receiving section configured to receive a configuration of a sounding reference signal (SRS) resource set on a second cell, and to receive, in a first cell, downlink control information indicating triggering of the SRS resource set; and a control section configured to determine, based on the SRS resource set and the downlink control information, a timing of transmission of a sounding reference signal (SRS) based on the SRS resource set. According to one aspect of the present disclosure, SRS triggering can be flexibly controlled.

### TECHNICAL FIELD

The present disclosure relates to a terminal, a radio communication method, and a base station in next-generation mobile communication systems.

### BACKGROUND ART

In a universal mobile telecommunications system (UMTS) network, specifications of long term evolution (LTE) have been drafted for the purpose of further increasing data rates, providing low latency, and the like (Non Patent Literature 1). Furthermore, the specifications of LTE-Advanced (3GPP Rel. 10 to 14) have been drafted for the purpose of further increasing capacity and advancement of LTE (third generation partnership project (3GPP) release (Rel.) 8 and 9).

Successor systems to LTE (for example, also referred to as 5th generation mobile communication system (5G), 5G+ (plus), 6th generation mobile communication system (6G), New Radio (NR), or 3GPP Rel. 15 and subsequent releases) are also being studied.

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

In a future radio communication system, a sounding reference signal (SRS) is used in a wide variety of applications. For example, SRS of NR is used not only for CSI measurement of uplink (UL) but also for CSI measurement of downlink (DL), beam management, and the like.

However, flexibility of triggering of the SRS has not been studied. If the SRS triggering is not flexibly performed, resource utilization efficiency, communication throughput, communication quality, and the like may deteriorate.

Therefore, an object of the present disclosure is to provide a terminal, a radio communication method, and a base station that flexibly control SRS triggering.

### Solution to Problem

A terminal according to one aspect of the present disclosure includes: a receiving section configured to receive a configuration of a sounding reference signal (SRS) resource set on a second cell, and to receive, in a first cell, downlink control information indicating triggering of the SRS resource set; and a control section configured to determine, based on the SRS resource set and the downlink control information, a timing of transmission of a sounding reference signal (SRS) based on the SRS resource set.

### Advantageous Effects of Invention

According to one aspect of the present disclosure. SRS triggering can be flexibly controlled.

### BRIEF DESCRIPTION OF DRAWINGS

FIG. 1 illustrates an example of a configuration of an SRS resource set.

FIG. 2 illustrates an example of association between a value of an SRS request field and the SRS resource set.

FIGS. 3A and 3B illustrate an example of restriction of A-SRS triggering.

FIG. 4 illustrates an example of an A-SRS triggering extension function.

FIG. 5 illustrates an example of an aspect 1-1.

FIG. 6 illustrates an example of an aspect 1-2.

FIG. 7 illustrates an example of a t-instruction in a second embodiment.

FIG. 8 illustrates an example of a t-instruction field size in a third embodiment.

FIG. 9 illustrates an example of a t-instruction in the third embodiment.

FIG. 10 is a diagram illustrating an example of a schematic configuration of a radio communication system according to one embodiment.

FIG. 11 is a diagram illustrating an example of a configuration of a base station according to one embodiment.

FIG. 12 is a diagram illustrating an example of a configuration of a user terminal according to one embodiment.

FIG. 13 is a diagram illustrating an exemplary hardware structure of a base station and a user terminal according to an embodiment.

FIG. 14 is a diagram illustrating an example of a vehicle according to one embodiment.

### DESCRIPTION OF EMBODIMENTS

### (SRS)

In NR, a sounding reference signal (SRS) has a wide range of usages. The SRS of the NR is used not only for uplink (UL) CSI measurement also used in existing LTE (LTE Rel. 8 to 14) but also for downlink (DL) CSI measurement, beam management and the like.

In the UE, one or a plurality of SRS resources may be configured. The SRS resource may be specified by an SRS resource index (SRI).

Each SRS resource may include one or a plurality of SRS ports (may correspond to one or a plurality of SRS ports). For example, the number of ports of each SRS may be one, two, four and the like.

For the UE, one or more SRS resource sets may be configured. One SRS resource set may be associated with a given number of SRS resources. The UE may commonly use a higher layer parameter for the SRS resources included in one SRS resource set. It is noted that, in the present disclosure, the resource set may be interchangeable with a set, a resource group, a group, and the like.

Information on the SRS resources or resource set may be configured in the UE by using higher layer signaling, physical layer signaling, or a combination thereof.

The SRS configuration information (for example, an RRC information element “SRS-Config”) may include SRS resource set configuration information, SRS resource configuration information, and the like.

The SRS resource set configuration information (for example, the RRC parameter “SRS-ResourceSet”) may include information on an SRS resource set identifier (ID) (SRS-ResourceSetId), a list of SRS resource IDs (SRS-ResourceId) used in the resource set, an SRS resource type (resourceType), and SRS usage (usage).

Here, the SRS resource type may indicate a behavior in the time domain of an SRS resource configuration (same time domain behavior), and may indicate any one of a periodic SRS (P-SRS), a semi-persistent SRS (SP-SRS), and an aperiodic SRS (A-SRS). It is noted that the UE may transmit the P-SRS and SP-SRS periodically (or periodically after activation). The UE may transmit the A-SRS based on the SRS request of the DCI.

In addition, the application of SRS (“usage” of the RRC parameter and “SRS-SetUse” of the L1 (Layer-1) parameter) may be, for example, beam management (beamManagement), codebook (CB), non-codebook (NCB), antenna switching (antennaSwitcing), or the like. For example, an SRS used for codebook or non-codebook may be used to determine a precoder for codebook-based or non-codebook-based physical uplink shared channel (PUSCH) transmission based on an SRI.

For an SRS used for beam management, it may be assumed that only one SRS resource per SRS resource set can be transmitted at a given time instant (given time instant). It is noted that, in a case where, in the same bandwidth part (BWP), a plurality of SRS resources falling under the same behavior in the time domain belong to different SRS resource sets, these SRS resources may be simultaneously transmitted.

The SRS resource configuration information (for example, the RRC parameter “SRS-Resource”) may include an SRS resource ID (SRS-ResourceId), the number of SRS ports, the SRS port numbers, a transmission comb, SRS resource mapping (such as a time and/or frequency resource position, a resource offset, a resource period, the number of repetitions, the number of SRS symbols, an SRS bandwidth, and the like), hopping-related information, an SRS resource type, a sequence ID, spatial relation information, and the like.

The UE may switch a bandwidth part (BWP) to transmit an SRS or may switch antennas slot by slot. In addition, the UE may apply at least one of in-slot hopping and inter-slot hopping to the SRS transmission.

### (A-SRS Triggering)

In Rel. 15/16, the A-SRS is triggered by an SRS Request field in the DCI.

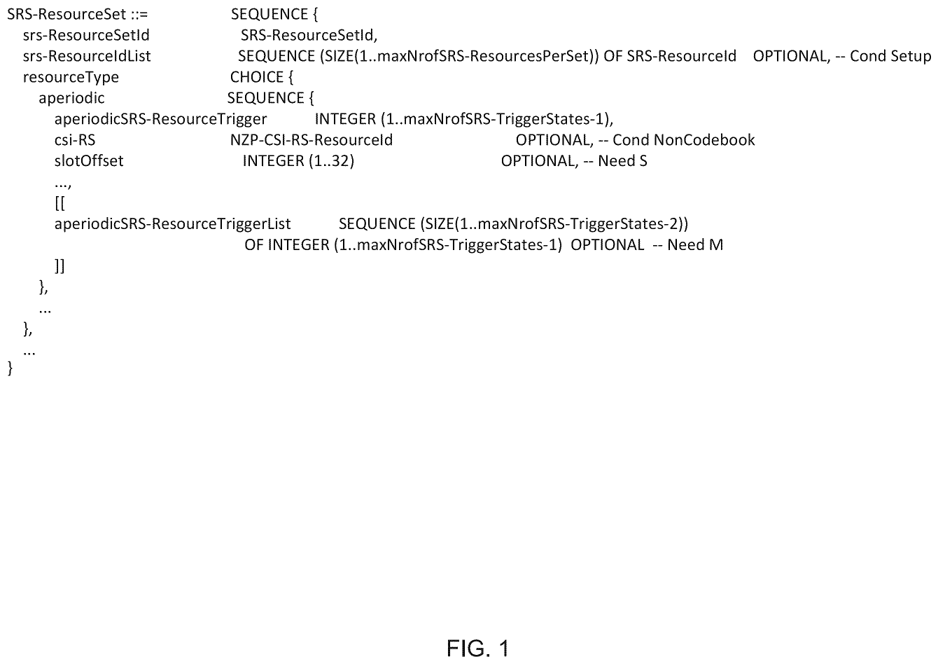

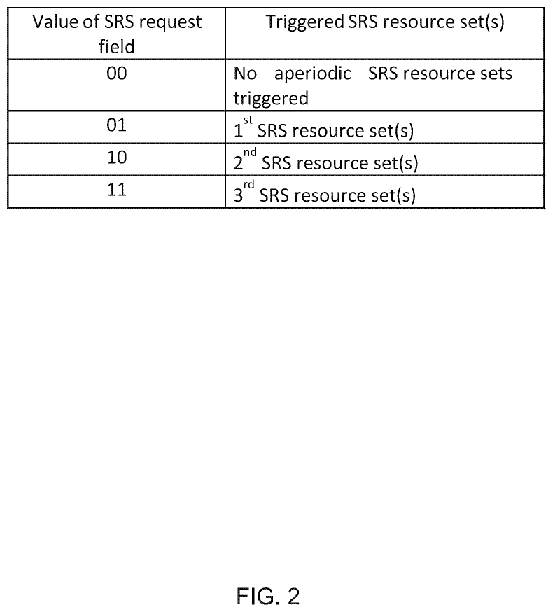

Each SRS resource set is configured in an SRS triggering state (A-SRS resource trigger, aperiodicSRS-ResourceTrigger={0, 1, 2, 3}) by RRC IE (FIG. 1), and each value (code point) of the SRS request field is associated with one or more SRS resource sets (FIG. 2). When the value of the SRS request field is 00, the SRS is not triggered. If the value of the SRS request field is not 00, an SRS resource in the SRS resource set corresponding to the SRS triggering state for that value is triggered (transmitted).

The A-SRS resource trigger (aperiodicSRS-ResourceTrigger) is a code point of the DCI, and the UE transmits the SRS according to a corresponding SRS resource set. An A-SRS resource trigger list (aperiodicSRS-ResourceTriggerList) is an additional list of code points of the DCI.

The existing SRS request is performed by a DCI format 0_1 or 1_1, and is accompanied by at least one of data scheduling and CSI triggering. When the DCI is allowed to be used only for the SRS requests, at least one DCI field of the data scheduling and the CSI triggering can be reused. For example, SRS triggering flexibility can be improved by increasing the size of the SRS request and using the SRS request to instruct time/frequency/orthogonal cover code (OCC)/cyclic shift resources for the SRS.

Extending at least one DCI format for A-SRS triggering has been studied. This DCI format may be a UE specific DCI format. This DCI format may be a new DCI format that is not accompanied by at least one of the data scheduling and the CSI triggering. The new DCI format may have the same size as that of the DCI format (for example, the existing DCI format, the DCI format 0_1) for the A-SRS triggering accompanied by at least one of the data scheduling and the CSI triggering. The new DCI format may be a DCI format that does not use some fields of the existing DCI format (some fields of the existing DCI format are set with invalid values or special values).

By at least one of a radio network temporary identifier (RNTI) that scrambles cyclic redundancy check (CRC) of the DCI, special values of one or more special fields in the DCI, and adding a new DCI field (for example, DCI format indicator) when configuration is performed by the RRC IE, the UE may determine (distinguish) whether the DCI format including the SRS request includes at least one of the data scheduling and the CSI triggering.

A time between triggering of the A-SRS and SRS transmission is a time k that is RRC configured for each SRS resource set, that is, a slotoffset parameter. The number of SRS sets configured for DL CSI acquisition is limited (up to two).

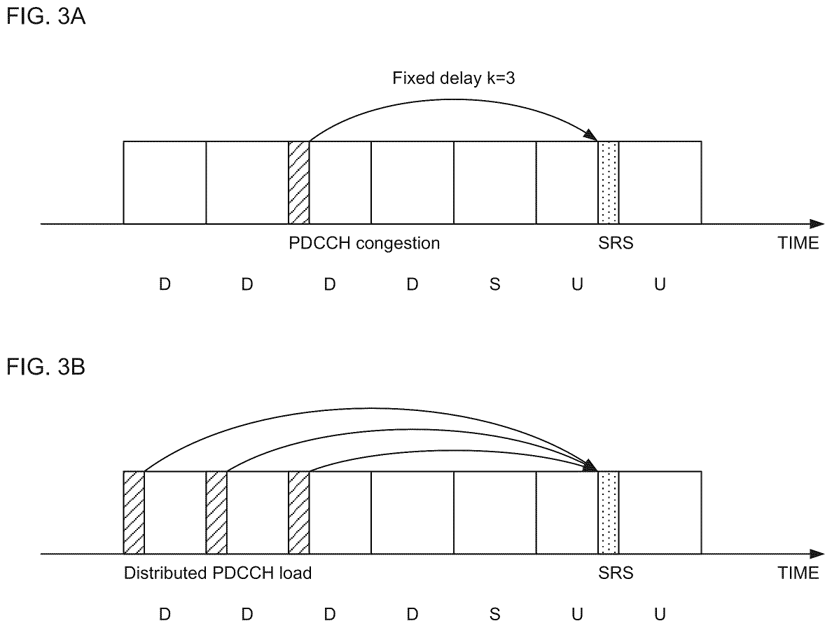

This means that the SRS must be triggered in a specific slot because a distance to a UL slot is fixed in the semi-static TDD configuration (FIG. 3A). In LTE, there is no such strict timing restriction (FIG. 3B).

For example, the A-SRS may not be triggered when needed due to PDCCH congestion, lack of UL or DL grant, and the like. This becomes a bottleneck in reciprocity-based MU-MIMO operation PDCCH capacity that is beneficial for triggering the SRS for a plurality of candidate users scheduled to transmit the SRSs simultaneously.

Even if triggering grants (PDCCH) to many UEs are transmitted in a plurality of DL slots to distribute PDCCH load, it is preferable to improve the flexibility of triggering of the A-SRS so that many UEs can transmit the SRS in the same UL slot.

### (Extension of A-SRS Triggering)

Extension of A-SRS triggering has been studied. An A-SRS resource set may be transmitted in the (t+1)th available slot (available slot) counted from a reference slot. t may be instructed from the DCI or may be instructed from the RRC (only one value of t may be configured in the RRC) (A-SRS triggering extension function). A candidate value of t may include at least 0.

The reference slot may be a slot instructed by an existing triggering offset (for example, slotoffset, legacy slot offset). When the DCI is transmitted in a slot n, and k is the existing triggering offset, the reference slot may be slot n+k. When slotOffset does not exist, the existing triggering offset may be 0.

The available slot may be a slot that satisfies the fact that there are UL or flexible symbols for a time domain location for all the SRS resources in a resource set and that satisfies UE capability with respect to minimum timing requirement between triggering DCI and all the SRS resources in the resource set. From the first symbol carrying SRS request DCI to the last symbol of the triggered SRS resource set, it may be stipulated that the UE does not assume to receive a slot format indicator (SFI) instruction, a cancellation (cancellation) instruction, or a dynamic scheduling of DL channels/signals on flexible symbols, which may change determination on the available slots.

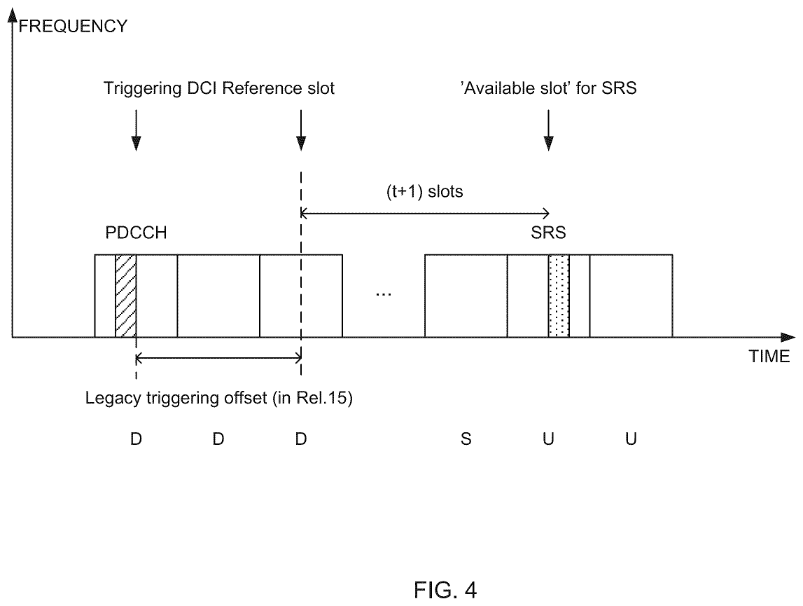

In the example of FIG. 4, the UE transmits the SRS in the next available UL slot after t slot instructed by the existing triggering offset configured by the SRS resource set. The available UL slot may be a U (uplink)/S (special) slot capable of transmitting the SRS. Accordingly, the A-SRS can be flexibly triggered.

For the DCI instruction of t in SRS triggering offset extension of Rel. 17, t may be instructed by adding a new configurable (for example, up to two bits) DCI field (for example, slot offset indicator (SOI) field) for both DCI scheduling PDSCH/PUSCH and DCI format 0_1/0_2 without data and without CSI request. The new DCI field may be applied only when a plurality of candidates for the value of t are configured. At least when the new DCI field is configured, there may be no further extension for instruction of t with respect to the DCI format 0_1/0_2 without the data and without the CSI request.

A list of t (a plurality of candidates for the value of t) may be configured for each SRS resource set. For example, the list may include K (integers from 0 to 4) values of t. The number of values of t configured between the plurality of SRS resource sets may be different. A size of the new DCI field may be determined depending on the configured maximum number of values of t. For example, when the maximum number of values of t is 1, the size of the new DCI field may be 0 bits. When there is no SRS resource set in which the value of t is configured, the UE may determine the slot offset according to Rel. 15.

However, there is an operation that is not clear in the triggering of the A-SRS. For example, it is not clear how t is configured/instructed. When the triggering of the A-SRS is not clear, communication quality, throughput, and the like may deteriorate.

Therefore, the present inventors conceived an A-SRS triggering method.

Hereinafter, embodiments according to the present disclosure will be described in detail with reference to the drawings. The radio communication method according to each of the embodiments may be applied independently, or may be applied in combination with others.

In the present disclosure, “A/B” and “at least one of A or B” may be interchangeable with each other. Furthermore, in the present disclosure, “A/B/C” may mean “at least one of A, B, and C”.

In the present disclosure, activate, deactivate, instruct (or indicate), select, configure, update, determine, and the like may be interchangeable with each other. In the present disclosure, support, control, can control, operate, can operate, and the like may be interchangeable with each other.

In the present disclosure, radio resource control (RRC), an RRC parameter, an RRC message, an upper layer parameter, an information element (IE), a setting, and the like may be interchangeable with each other. In the present disclosure, a Medium Access Control control element (MAC control element (CE)), an update command, an activation/deactivation command, and the like may be interchangeable with each other.

In the present disclosure, the higher layer signaling may be any of, for example, radio resource control (RRC) signaling, medium access control (MAC) signaling, broadcast information, and the like, or a combination thereof.

In the present disclosure, the MAC signaling may use, for example, the MAC control element (MAC CE), a MAC protocol data unit (PDU), or the like. The broadcast information may be, for example, a master information block (MIB), a system information block (SIB), remaining minimum system information (RMSI), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeable with each other. In the present disclosure, a sequence, a list, a set, a group, a cohort, a cluster, a subset, and the like may be interchangeable with each other.

In the present disclosure, the trigger, the request, and the schedule may be interchangeable with each other.

In the present disclosure, the DCI, the DCI format, at least one of the DCI formats 0_1, 0_2, 1_1, 1_2, and 2_3, the DCI that is not accompanied by the data scheduling/the CSI triggering, the DCI that is not accompanied by the data scheduling and the CSI triggering, the DCI for SRS triggering that is not accompanied by the data scheduling/the CSI triggering, the DCI that is accompanied by the data scheduling/the CSI triggering, the DCI format 0_1/0_2 that is accompanied by the data/the CSI (scheduling/triggering), and the DCI format 0_1/0_2 that is not accompanied by the data/the CSI (scheduling/triggering) may be interchangeable with each other.

In the present disclosure, SRS resource set, SRS-ResourceSet, SRS positioning resource set, and SRS-PosResourceSet may be interchangeable with each other.

In the present disclosure, aperiodicSRS-ResourceTrigger, entry in the aperiodicSRS-Resource TriggerList, A-SRS resource trigger index, and code point (value) of the SRS request field may be interchangeable with each other.

In the present disclosure, a transmission timing of the SRS, a timing instructed by t, an existing triggering offset, and a timing based on t may be interchangeable with each other.

### (Radio Communication Method)

In each embodiment, a t-instruction field, a slot offset instruction (SOI) field, a triggering offset instruction field, a timing instruction field, and a t-instruction bit may be interchangeable with each other.

In each embodiment, the t-instruction field size and the t-instruction bit width may be interchangeable with each other.

In each embodiment, a list of values of t, a t-list, candidates of values of t, and a t-list in the SRS resource set may be interchangeable with each other.

In each embodiment, a specific BWP or a specific cell, all the BWPs in one CC, BWPs in which triggering DCI is received, all the BWPs in all the CCs, BWP/CC in which at least one value of t is configured in all the BWPs in all the CCs, all the configured BWPs in all the configured CCs in a band supporting a function of the t-instruction (Rel. 17 function of SRS triggering offset extension), and all the configured BWPs in all the configured CCs in a specific band may be interchangeable with each other. At least one value of t may be configured in at least one SRS resource set in any BWP in a certain CC in a specific band.

The function described in each embodiment may be interchangeable with the t-instruction.

In each embodiment, a first BWP/CC, a first cell, a first CC, and a BWP/CC for scheduling/triggering/triggering DCI reception may be interchangeable with each other. In each embodiment, a second BWP/CC, a second cell, a second CC, and a CC of the SRS resource set including a value of scheduled/triggered/SRS transmission/SRS resource set/t may be interchangeable with each other.

### First Embodiment

This embodiment relates to the t-instruction field.

A size (for example, ceil (log 2(K_max)) bits) of the t-instruction field may be determined based on a maximum value (K_max) of the number (K) of values of t configured for all the SRS resource sets.

In each of the SRS resource sets, it is not clear which bit in the t-instruction field is used for the instruction of t.

### <<Aspect 1-1>>

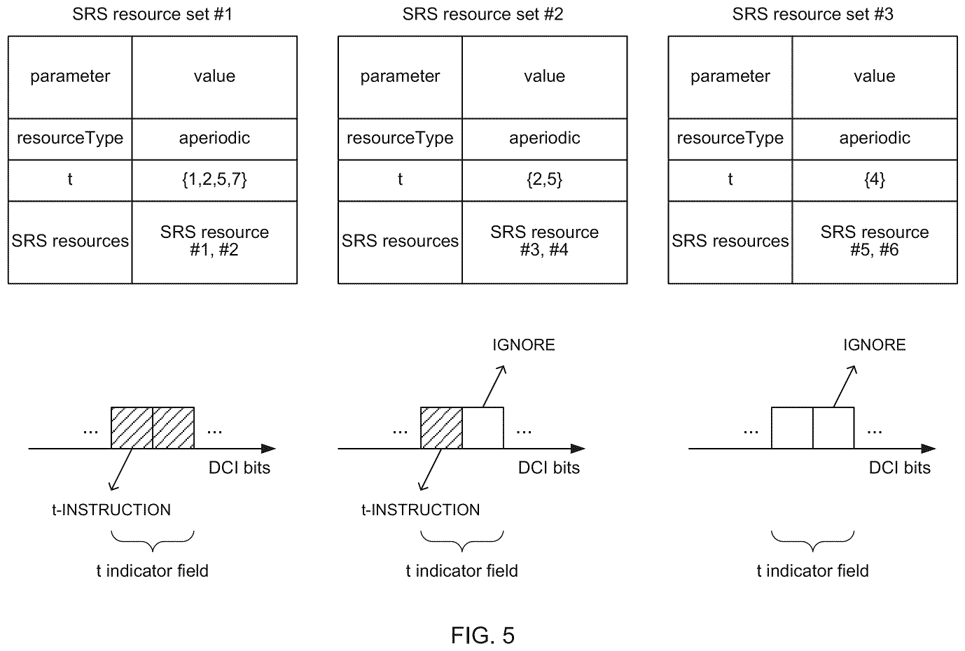

In the example of FIG. 5, SRS resource sets #1 to #3 are configured. Since the maximum values (four values) of t are configured for the SRS resource set #1, the size of the t-instruction field may be two bits.

The t-instruction field may follow at least one of the following instruction cases 1-1 to 1-3.

### [Instruction Case 1-1]

When the SRS request field instructs the SRS resource set (SRS resource set #1) accompanied by K_max values of t, the t-instruction field instructs t by using all bits.

### [Instruction Case 1-2]

When the SRS request field instructs the SRS resource set (SRS resource set #2) accompanied by K (1<<<K_max) values of t, the t-instruction field instructs t by using some bits (least significant bit (LSB) or most significant bit (MSB) or high-order N bits or low-order N bits).

### [Instruction Case 1-3]

When the SRS request field instructs the SRS resource set (SRS resource set #3) accompanied by one value of t, the UE ignores two bits of the t-instruction field and uses one value of t configured in the SRS resource set.

### <<Aspect 1-2>>

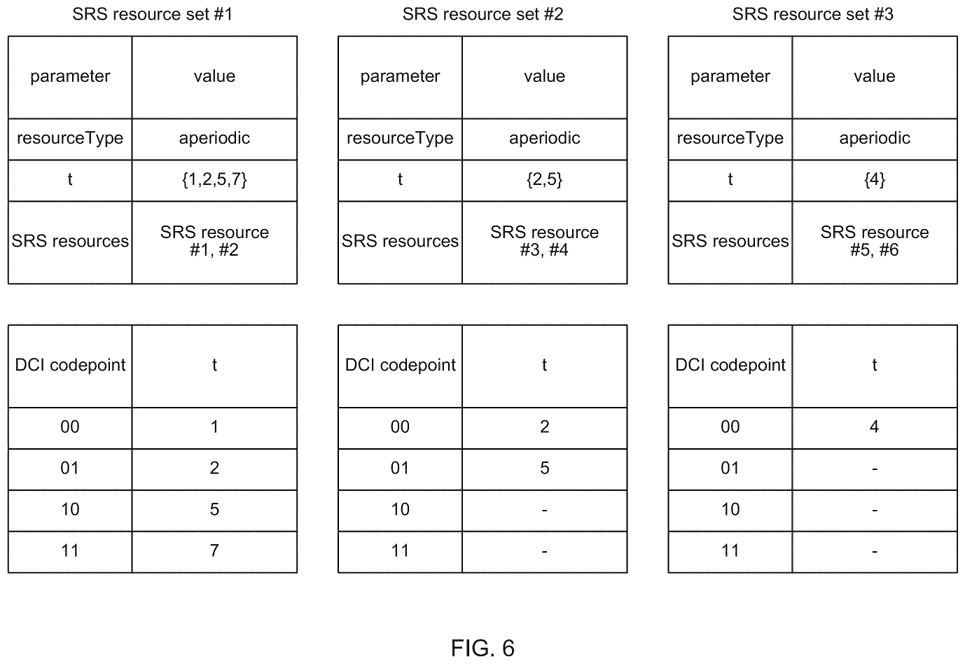

In the example of FIG. 6, the SRS resource sets #1 to #3 are configured. Since the maximum values (four values) of t are configured for the SRS resource set #1, the size of the t-instruction field may be two bits.

The t-instruction field may follow at least one of the following instruction cases 2-1 to 2-3.

### [Instruction Case 2-1]

When the SRS request field instructs the SRS resource set (SRS resource set #1) accompanied by K_max values of t, the t-instruction field instructs t by using one of all code points.

### [Instruction Case 2-2]

When the SRS request field instructs the SRS resource set (SRS resource set #2) accompanied by K (1<<<K_max) values of t, the t-instruction field instructs t by using one of some code points (minimum/lowest/maximum/highest code points, code points less than or equal to a specific value, code points greater than or equal to a specific value) in all code points.

### [Instruction Case 2-3]

When the SRS request field instructs the SRS resource set (SRS resource set #3) accompanied by one value of t, the UE ignores all code points in the t-instruction field, and uses one value of t configured for the SRS resource set.

### <<Aspect 1-3>>

The SRS request field may instruct/trigger one or more SRS resource sets. The UE may follow the following t-number stipulation 1 or 2.

[t-Number Stipulation 1]

It may be stipulated that the UE does not assume that a plurality of SRS resource sets (the number of configured values of t is different among the plurality of SRS resource sets) accompanied by different number of values of t are instructed by one code point of the SRS request field. It may be stipulated that the UE does not assume that a plurality of SRS resource sets (the number of configured values of t is different among the plurality of SRS resource sets) accompanied by different numbers of values of t are configured corresponding to the same aperiodic triggering state.

[t-Number Stipulation 2]

For the UE, a plurality of SRS resource sets (the number of configured values of t is different among the plurality of SRS resource sets) accompanied by different number of values of t may be instructed by one code point of the SRS request field. For the UE, a plurality of SRS resource sets (the number of configured values of t is different among the plurality of SRS resource sets) accompanied by different numbers of values of t may be configured corresponding to the same aperiodic triggering state.

In the t-number stipulation 2, the t-instruction may follow the following t-instruction method 1 or 2.

[[t-Instruction Method 1]]

The t-instruction may follow a list of values of t configured for the SRS resource set accompanied by a maximum value of the number of values of t. For example, in the example of FIG. 5 or FIG. 6, when the SRS resource sets #1 and #2 are instructed by one code point of the SRS request field, the t-instruction field instructs a value of t by using a list of values of t configured for the SRS resource set #1. In this case, the size of the t-instruction field can instruct the maximum value of the number of values of t, so that all bits/code points of the t-instruction field can be used, which is efficient.

[t-Instruction Method 2]

The t-instruction may follow a list of values of t configured for a specific SRS resource set. For example, the specific SRS resource set may be an SRS resource set accompanied by a lowest/highest SRS resource set ID. In this case, a UE operation is simplified.

### <<Aspect 1-4>>

The SRS request field may instruct/trigger one or more SRS resource sets. When a plurality of SRS resource sets (regardless of the number of values of t configured for the SRS resource set) are instructed by one code point of the SRS request field, there is a problem in that the t-instruction uses the list of t values configured for which SRS resource set. The SRS request field may follow the following t-list stipulation 1 or 2.

[t-List Stipulation 1]

It may be stipulated that the UE does not assume that a plurality of SRS resource sets (a list of configured values of t is different among the plurality of SRS resource sets) accompanied by different lists of t are instructed by one code point of the SRS request field. It may be stipulated that the UE does not assume that a plurality of SRS resource sets (a list of configured values of t is different among the plurality of SRS resource sets) accompanied by different lists of t are configured corresponding to the same aperiodic triggering state.

[t-List Stipulation 2]

For the UE, a plurality of SRS resource sets (a list of configured values of t is different among the plurality of SRS resource sets) accompanied by different lists of t may be instructed by one code point of the SRS request field. For the UE, a plurality of SRS resource sets (a list of configured values of t is different among the plurality of SRS resource sets) accompanied by different lists of t may be configured corresponding to the same aperiodic triggering state.

In the t-list stipulation 2, the t-instruction may follow the following t-instruction method 1 or 2.

[t-Instruction Method 1]

The t-instruction may follow a list of values of t configured for the SRS resource set accompanied by a maximum value of the number of values of t. For example, in the example of FIG. 5 or FIG. 6, when the SRS resource sets #1 and #2 are instructed by one code point of the SRS request field, the t-instruction field instructs a value of t by using a list of values of t configured for the SRS resource set #1. In this case, the size of the t-instruction field can instruct the maximum value of the number of values of t, so that all bits/code points of the t-instruction field can be used, which is efficient.

[t-Instruction Method 2]

The t-instruction may follow a list of values of t configured for a specific SRS resource set. For example, the specific SRS resource set may be an SRS resource set accompanied by a lowest/highest SRS resource set ID. In this case, a UE operation is simplified.

According to this embodiment, even when a plurality of SRS resource sets are configured, t can be appropriately instructed.

### <Analysis>

The t-instruction may follow at least one of the following options 1 to 3.

### [Option 1]

The t-instruction field size depends on the maximum number of t-values configured for any A-SRS resource set across all the BWPs in one CC.

### [Option 2]

The t-instruction field size depends on the maximum number of t-values configured for the A-SRS resource set in the BWPs in which the (triggering) DCI is received.

### [Option 3]

The t-instruction field size depends on the maximum number of t-values configured for all the A-SRS resource sets across all the BWPs in all the CCs.

### Second Embodiment

When the t-instruction field size is determined based on the SRS resource set accompanied by the maximum number of t-values among all the SRS resource sets configured in a certain BWP or a certain CC, as in the option 1/2, the t-instruction for cross carrier A-SRS triggering becomes problem.

This embodiment relates to t-instruction for the cross carrier A-SRS triggering in the option 1/2.

<<t-Instruction Function>

When the cross carrier A-SRS triggering is performed, both a first CC (first BWP/CC) for scheduling/triggering/DCI reception and a second CC (second BWP/CC) for scheduled/triggered/SRS transmission may support a t-instruction function.

When the cross carrier A-SRS triggering is performed, the t-instruction may be configured for both the first CC and the second CC. When the cross carrier A-SRS triggering is performed, the value (list) of t may be configured for at least one SRS resource set in the first CC/the second CC.

When the cross carrier A-SRS triggering is performed, sizes of the t-instruction fields may be equal in both the first CC and the second CC. The maximum number of values of t configured for all the SRS resource sets in all the BWPs/CCs may be equal. The sizes of the t-instruction fields determined by the number of values of t configured for (all) the SRS resource sets in all the BWPs/CCs may be equal.

When the cross carrier A-SRS triggering is performed, the size of the t-instruction field may be different between the first CC and the second CC. The size of the t-instruction field in the DCI in the first CC may be determined by the maximum number of t configured for (all) SRS resource sets in the first CC. The size of the t-instruction field in the DCI in the first CC may be determined by the maximum number of t configured for (all) SRS resource sets in the second CC.

When the size of the t-instruction field in the first CC is greater than the size of the t-instruction field in the second CC, the UE may ignore some bits/code points of the t-instruction field in the first CC and use remaining bits/code points.

When the size of the t-instruction field in the first CC is less than the size of the t-instruction field in the second CC, the UE may not be instructed with some values of t configured for the SRS resource set of the second CC.

### <<SRS Resource Set Configuration>>

The SRS resource set used for the cross carrier A-SRS triggering may be configured for the BWP/CC (second BWP/CC) that transmits the SRS.

The SRS resource set used for the cross carrier A-SRS triggering may be configured for the BWP/CC (first BWP/CC) that receives the triggering DCI.

The size of the t-instruction field in the first BWP/CC may be determined based on the maximum number of values of t (SRS resource set having the largest number of values in the list of t) in the SRS resource set configured in the first BWP/CC. In this case, the size of the DCI for the cross carrier A-SRS triggering and the size of the DCI for self-carrier A-SRS triggering can be equal, and the UE can operate appropriately.

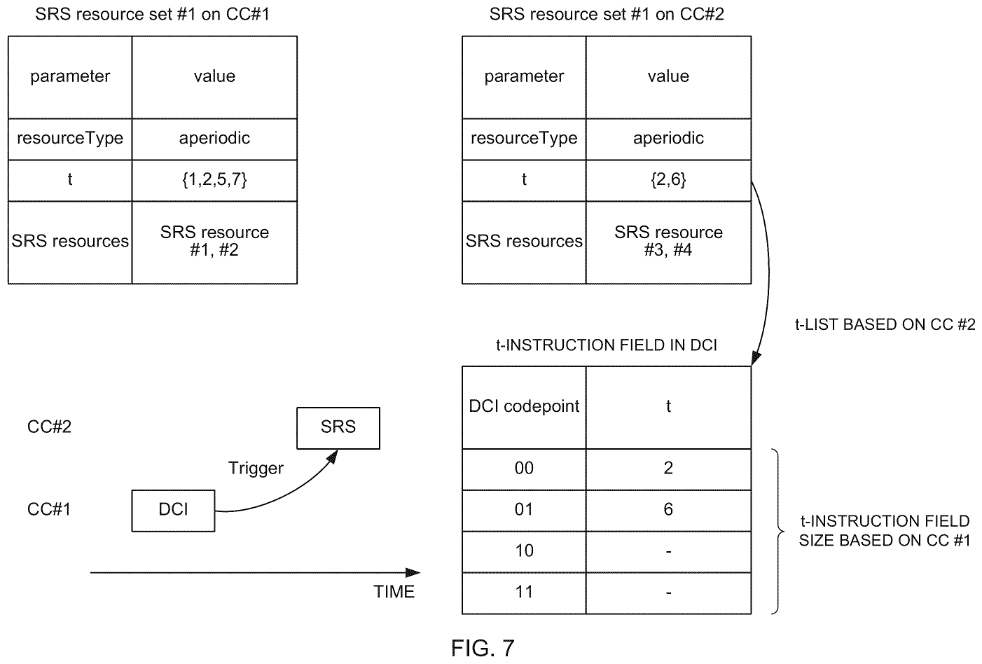

In the example of FIG. 7, the SRS resource set #1 on a CC #1 (first CC) and the SRS resource set #1 on a CC #2 (second CC) are configured. DCI on the CC #1 triggers the SRS resource set #1 on the CC #2. Based on the number of values of t (the size of the list) configured for the SRS resource set #1 on the CC #1, the size of the t-instruction field in the DCI may be determined. The t-instruction field may instruct one value in the list of t configured for the SRS resource set #1 on the CC #2.

The size of the t-instruction field in the first BWP/CC may be determined based on the maximum number of values of t (SRS resource set having the largest number of values in the list of t) in the SRS resource set configured in the second BWP/CC.

According to this embodiment, in the option 1/2, t can be appropriately instructed.

### Third Embodiment

This embodiment relates to the t-instruction for the cross carrier A-SRS triggering in the option 3.

The UE supporting a function (function 1) of the t-instruction may assume that the t-instruction field is inserted (included) in the DCI and may be instructed an available slot (SRS transmission slot) by t.

It may be stipulated that the UE that does not support the function 1 does not assume that the t-instruction field is inserted (included) in the DCI because the UE performs Rel. 15/16 operation.

For example, when a t-list {0, 1, 2, 3} is configured in a band (CC) #A and a t-list {0, 1} is configured in a band #B, in the option 3, the size of the t-instruction field may be two bits in both the band #A and the band B. In the option 3, when no t-list is configured in a band #C, the size of the t-instruction field is two bits also in the band #C, and the UE needs to support the function 1 in all bands.

### <<Variations of Option 3>>

The t-instruction may follow at least one of the following options 4 to 6.

### [Option 4]

The t-instruction field size depends on the maximum number of t-values configured for all the A-SRS resource sets across BWPs/CCs in which at least one value of tis configured among all the BWPs in all the CCs.

### [Option 5]

The t-instruction field size depends on the maximum number of t-values configured for all the A-SRS resource sets across all the configured BWPs in all the configured CCs in a band supporting the function of the t-instruction (Rel. 17 function of SRS triggering offset extension).

In the option 5, for the UE that reports to support the function of the t-instruction in the band #A and the band #B, when the value of t is configured for the SRS resource set in any BWP/CC in the band #A, and the value of t is not configured for the SRS resource set in any BWP/CC in the band #B, the t-instruction field also exists in the band #B.

### [Option 6]

The t-instruction field size depends on the maximum number of t-values configured for all the A-SRS resource sets across all the configured BWPs in all the configured CCs in a specific band. At least one value of t may be configured in at least one SRS resource set in any BWP in a certain CC in a specific band. When the value of t is not configured in the SRS resource set in any BWP in a certain CC in a certain band, the band may follow a mechanism of Rel. 15/16 for determining the SRS slot offset.

When at least one value of t is configured in at least one SRS resource set in any BWP in a certain CC in a certain band, the band may follow the mechanism of Rel. 15/16 for determining the SRS slot offset.

### <<SRS Resource Set Configuration>>

The SRS resource set used for the cross carrier A-SRS triggering may be configured for the BWP/CC (second BWP/CC) that transmits the SRS.

The SRS resource set used for the cross carrier A-SRS triggering may be configured for the BWP/CC (first BWP/CC) that receives the triggering DCI.

In all the BWPs/CCs in which at least one value of t is configured, the size of the t-instruction field in the first BWP/CC may be determined based on the maximum number of values of t (the SRS resource set having the largest number of values in the list of t). The A-SRS triggering DCI in the BWP/CC in which at least one value of t is configured may include the t-instruction field. The A-SRS triggering DCI in the BWP/CC in which the value of t is not configured may not include the t-instruction field.

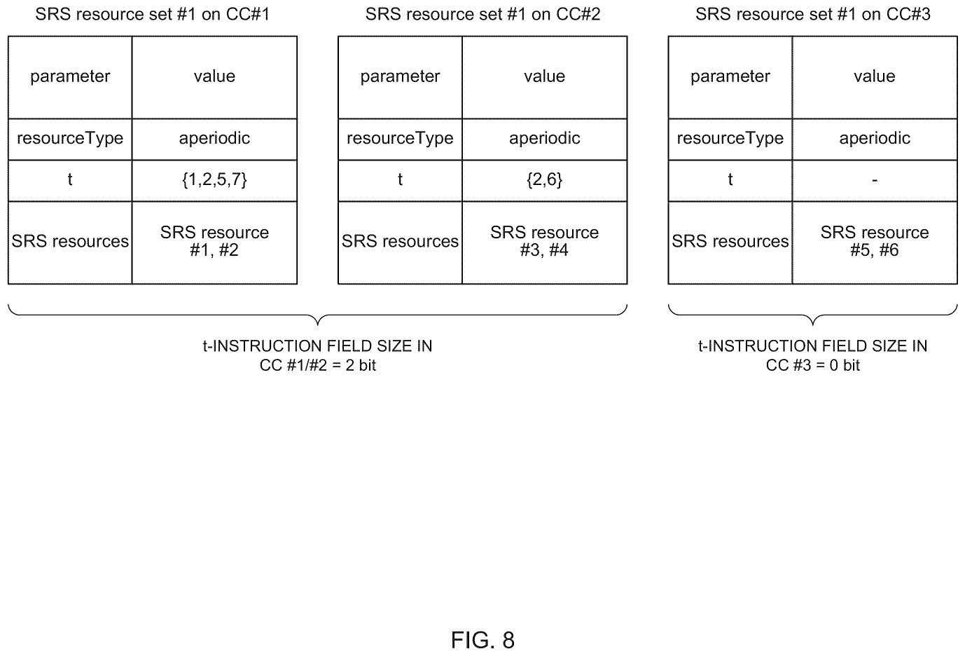

In the example of FIG. 8, a list of values of t is configured for the SRS resource set #1 on the CC #1, a list of values of t is configured for the SRS resource set #1 on the CC #2, and a list of values of t is not configured for the SRS resource set #1 on the CC #3. In the CCs #1 and #2, since the maximum number of values of t in one SRS resource set is four, the size of the t-instruction field in the triggering DCI in the CC #1 and #2 is two bits. The size of the t-instruction field in the triggering DCI in the CC #3 is 0 bits (the triggering DCI in the CC #3 does not include the t-instruction field).

Between two BWPs/CCs in which at least one value of t is configured, A-SRS triggering of cross carrier/cross BWP may be performed.

The A-SRS triggering of the cross carrier/cross BWP may not be performed between the BWP/CC in which at least one value of t is configured and the BWP/CC in which the value of t is not configured.

The A-SRS triggering of the cross carrier/cross BWP may be performed between the BWP/CC in which at least one value of t is configured and the BWP/CC in which the value of t is not configured. In this case, the t-instruction may follow the following t-instruction method 1 or 2.

[[t-Instruction Method 1]]

The t-instruction may follow a list of values of t configured for the SRS resource set accompanied by a maximum value of the number of values of t. In this case, the size of the t-instruction field can instruct the maximum value of the number of values of t, so that all bits/code points of the t-instruction field can be used, which is efficient.

[[t-Instruction Method 2]]

The t-instruction may follow a list of values of t configured for a specific SRS resource set. For example, the specific SRS resource set may be an SRS resource set accompanied by a lowest/highest SRS resource set ID. In this case, a UE operation is simplified.

<<t-Instruction Function>>

When the cross carrier A-SRS triggering is performed, both a first CC (first BWP/CC) for scheduling/triggering/DCI reception and a second CC (second BWP/CC) for scheduled/triggered/SRS transmission may support a t-instruction function.

When the cross carrier A-SRS triggering is performed, the t-instruction may be configured for both the first CC and the second CC. When the cross carrier A-SRS triggering is performed, the value (list) of t may be configured for at least one SRS resource set in the first CC/the second CC.

When the cross carrier A-SRS triggering is performed, sizes of the t-instruction fields may be equal in both the first CC and the second CC. The maximum number of values of t configured for all the SRS resource sets in all the BWPs/CCs may be equal. The sizes of the t-instruction fields determined by the number of values of t configured for (all) the SRS resource sets in all the BWPs/CCs may be equal.

When the cross carrier A-SRS triggering is performed, the size of the t-instruction field may be different between the first CC and the second CC. The size of the t-instruction field in the DCI in the first CC may be determined by the maximum number of t configured for (all) SRS resource sets in the first CC. The size of the t-instruction field in the DCI in the first CC may be determined by the maximum number of t configured for (all) SRS resource sets in the second CC.

When the size of the t-instruction field in the first CC is greater than the size of the t-instruction field in the second CC, the UE may ignore some bits/code points of the t-instruction field in the first CC and use remaining bits/code points.

When the size of the t-instruction field in the first CC is less than the size of the t-instruction field in the second CC, the UE may not be instructed with some values of t configured for the SRS resource set of the second CC.

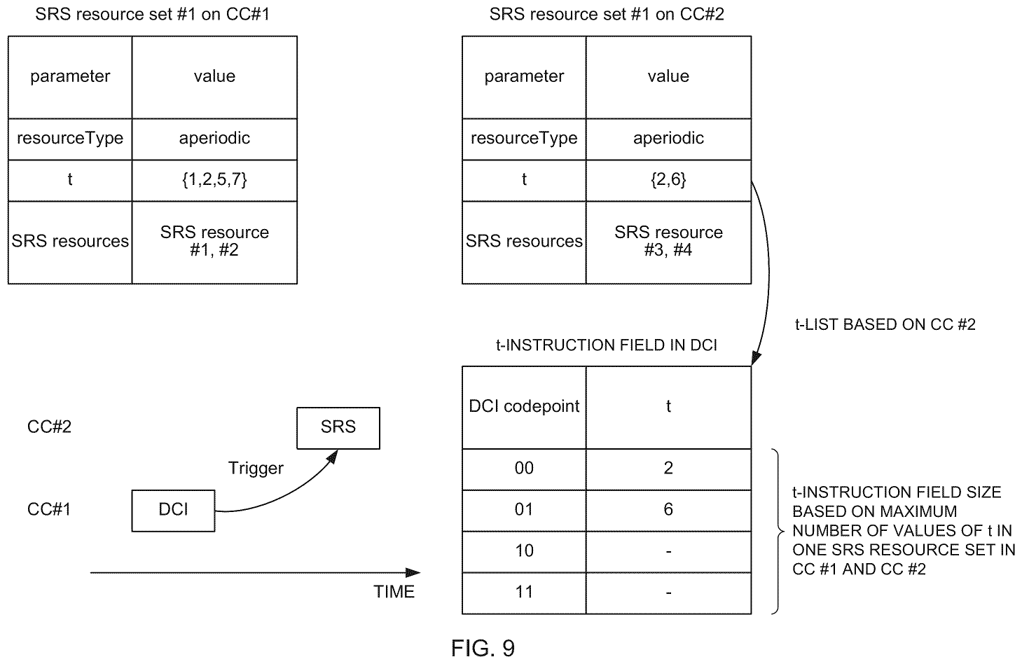

In the example of FIG. 9, the SRS resource set #1 on the CC #1 (first CC) and the SRS resource set #1 on the CC #2 (second CC) are configured. DCI on the CC #1 triggers the SRS resource set #1 on the CC #2. Based on the number of values of t (the size of the list) configured for the SRS resource set #1 on the CC #1, the size of the t-instruction field in the DCI may be determined. The t-instruction field may instruct one value in the list of t configured for the SRS resource set #1 on the CC #2.

The size of the t-instruction field in the first BWP/CC may be determined based on the maximum number of values of t (SRS resource set having the largest number of values in the list of t) in the SRS resource set configured in the second BWP/CC.

According to this embodiment, in the option 3/4, t can be appropriately instructed.

### Other Embodiments

### <<UE Capability Information/Higher Layer Parameter>>

A higher layer parameter (RRC IE)/UE capability corresponding to a function (feature) in each of the above embodiments may be defined. The higher layer parameter may indicate whether the function is activated. The UE capability may indicate whether the UE supports the function.

The UE in which the higher layer parameter corresponding to the function is configured may perform the function. “The UE in which the higher layer parameter corresponding to the function is not configured does not perform the function (for example, according to Rel. 15/16)” may be defined.

The UE that has reported/transmitted the UE capability indicating support for the function may perform the function. “The UE that does not report the UE capability indicating support for the function does not perform the function (for example, according to Rel. 15/16)” may be defined.

When the UE reports/transmits the UE capability indicating the support for the function, and a higher layer parameter corresponding to the function is configured, the UE may perform the function. “When the UE does not report/transmit the UE capability indicating the support for the function or the higher layer parameter corresponding to the function is not configured, the UE does not perform the function (for example, according to Rel. 15/16)” may be defined.

Among the foregoing plurality of embodiments, which embodiment/option/choice/function is used may be configured by higher layer parameters, may be reported by the UE as UE capability, may be defined in the specifications, or may be determined by the reported UE capability and the configuration of the higher layer parameters.

The UE capability may indicate whether to support at least one of the following functions.
t-instruction.
SRS triggering of cross carrier/cross BWP.
The maximum value of the number of values of t in all the SRS resource sets included in a certain BWP/CC may be different for each BWP/CC.
A-SRS triggering extension function.
Configuration of a new field (t-indicator field).
Dynamically changing t by DCI.
A plurality of values of t are configured for one SRS resource set.
Different number of t values is configured for a plurality of different SRS resource sets.

Configuration of the higher layer parameter may be interchangeable with configuration of the value of t in at least one SRS resource set in a certain BWP/CC.

According to the above UE capability/higher layer parameters, the UE can realize the above functions while maintaining compatibility with existing specifications.

### (Radio Communication System)

Hereinafter, a configuration of a radio communication system according to one embodiment of the present disclosure will be described. In this radio communication system, communication is performed using any one of the radio communication methods according to the embodiments of the present disclosure or a combination thereof.

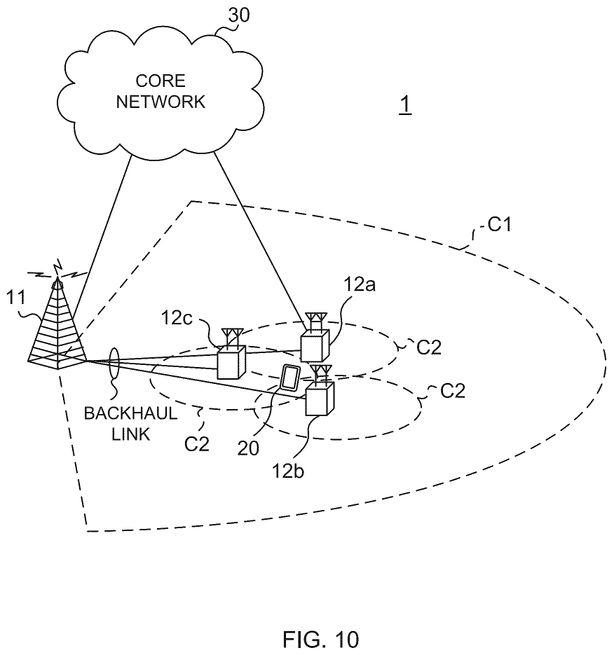

FIG. 10 is a diagram illustrating an example of a schematic configuration of the radio communication system according to one embodiment. A radio communication system 1 may be a system that implements communication using long term evolution (LTE), 5th generation mobile communication system New Radio (5G NR), and the like drafted as the specification by third generation partnership project (3GPP).

Further, the radio communication system 1 may support dual connectivity (multi-RAT dual connectivity (MR-DC)) between a plurality of radio access technologies (RATs). The MR-DC may include dual connectivity between LTE (evolved universal terrestrial radio access (E-UTRA)) and NR (E-UTRA-NR dual connectivity (EN-DC)), dual connectivity between NR and LTE (NR-E-UTRA dual connectivity (NE-DC)), and the like.

In the EN-DC, an LTE (E-UTRA) base station (eNB) is a master node (MN), and an NR base station (gNB) is a secondary node (SN). In the NE-DC, an NR base station (gNB) is MN, and an LTE (E-UTRA) base station (eNB) is SN.

The radio communication system 1 may support dual connectivity between a plurality of base stations in the same RAT (for example, dual connectivity in which both MN and SN are NR base stations (gNB) (NR-NR dual connectivity (NN-DC)).

The radio communication system 1 may include a base station 11 that forms a macro cell C1 with a relatively wide coverage, and base stations 12 (12a to 12c) that are disposed within the macro cell C1 and that form small cells C2 narrower than the macro cell C1. A user terminal 20 may be positioned in at least one cell. The arrangement, number, and the like of cells and the user terminals 20 are not limited to the aspects illustrated in the drawings. Hereinafter, the base stations 11 and 12 will be collectively referred to as “base stations 10” when the base stations 11 and 12 are not distinguished from each other.

The user terminal 20 may be connected to at least one of the plurality of base stations 10. The user terminal 20 may use at least one of carrier aggregation (CA) using a plurality of component carriers (CC) and dual connectivity (DC).

Each CC may be included in at least one of a first frequency band (frequency range 1 (FR1)) or a second frequency band (frequency range 2 (FR2)). The macro cell C1 may be included in the FR1, and the small cell C2 may be included in the FR2. For example, the FR1 may be a frequency band of 6 GHz or less (sub-6 GHZ), and the FR2 may be a frequency band higher than 24 GHZ (above-24 GHZ). It is noted that the frequency bands, definitions, and the like of the FR1 and FR2 are not limited thereto, and, for example, the FR1 may correspond to a frequency band higher than the FR2.

Further, the user terminal 20 may perform communication on each CC using at least one of time division duplex (TDD) and frequency division duplex (FDD).

The plurality of base stations 10 may be connected to each other in a wired manner (for example, an optical fiber, an X2 interface, or the like in compliance with common public radio interface (CPRI)) or in a radio manner (for example, NR communication). For example, when NR communication is used as a backhaul between the base stations 11 and 12, the base station 11 corresponding to a higher-level station may be referred to as an integrated access backhaul (IAB) donor, and the base station 12 corresponding to a relay station (relay) may be referred to as an IAB node.

The base station 10 may be connected to a core network 30 via another base station 10 or directly. The core network 30 may include, for example, at least one of evolved packet core (EPC), 5G core network (5GCN), next generation core (NGC), or the like.

The user terminal 20 may be a terminal that corresponds to at least one of communication methods such as LTE, LTE-A, and 5G.

In the radio communication system 1, a radio access method based on orthogonal frequency division multiplexing (OFDM) may be used. For example, in at least one of downlink (DL) and uplink (UL), cyclic prefix OFDM (CP-OFDM), discrete Fourier transform spread OFDM (DFT-s-OFDM), orthogonal frequency division multiple access (OFDMA), single carrier frequency division multiple access (SC-FDMA), and the like may be used.

The radio access method may be referred to as a waveform. It is noted that in the radio communication system 1, another radio access method (for example, another single carrier transmission method or another multi-carrier transmission method) may be used as the UL and DL radio access method.

In the radio communication system 1, a downlink shared channel (physical downlink shared channel (PDSCH)) shared by the user terminals 20, a broadcast channel (physical broadcast channel (PBCH)), a downlink control channel (physical downlink control channel (PDCCH)), and the like may be used as downlink channels.

In the radio communication system 1, an uplink shared channel (physical uplink shared channel (PUSCH)) shared by the user terminals 20, an uplink control channel (physical uplink control channel (PUCCH)), a random access channel (physical random access channel (PRACH)), and the like may be used as uplink channels.

User data, higher layer control information, a system information block (SIB), and the like are transmitted on the PDSCH. The user data, higher layer control information, and the like may be transmitted on the PUSCH. Furthermore, a master information block (MIB) may be transmitted on the PBCH.

Lower layer control information may be transmitted on the PDCCH. The lower layer control information may include, for example, downlink control information (DCI) including scheduling information of at least one of the PDSCH and the PUSCH.

It is noted that the DCI that schedules the PDSCH may be referred to as DL assignment, DL DCI, or the like, and the DCI that schedules PUSCH may be referred to as UL grant, UL DCI, or the like. It is noted that the PDSCH may be interchangeable with DL data, and the PUSCH may be interchangeable with UL data.

For detection of the PDCCH, a control resource set (CORESET) and a search space may be used. The CORESET corresponds to a resource that searches for DCI. The search space corresponds to a search area and a search method for PDCCH candidates. One CORESET may be associated with one or more search spaces. UE may monitor CORESET associated with a certain search space based on search space configuration.

One search space may correspond to a PDCCH candidate corresponding to one or more aggregation levels. One or more search spaces may be referred to as a search space set. It is noted that “search space”, “search space set”, “search space configuration”, “search space set configuration”, “CORESET”, “CORESET configuration”, and the like in the present disclosure may be interchangeable with each other.

Uplink control information (UCI) including at least one of channel state information (CSI), delivery acknowledgement information (which may be referred to as, for example, hybrid automatic repeat request acknowledgement (HARQ-ACK), ACK/NACK, or the like), and scheduling request (SR) may be transmitted on the PUCCH. A random access preamble for establishing connection with a cell may be transmitted on the PRACH.

It is noted that in the present disclosure, downlink, uplink, and the like may be expressed without “link”. Various channels may be expressed without adding “physical” at the beginning thereof.

In the radio communication system 1, a synchronization signal (SS), a downlink reference signal (DL-RS), and the like may be transmitted. In the radio communication system 1, a cell-specific reference signal (CRS), a channel state information reference signal (CSI-RS), a demodulation reference signal (DMRS), a positioning reference signal (PRS), a phase tracking reference signal (PTRS), or the like may be transmitted as the DL-RS.

The synchronization signal may be, for example, at least one of a primary synchronization signal (PSS) and a secondary synchronization signal (SSS). A signal block including the SS (PSS or SSS) and the PBCH (and the DMRS for the PBCH) may be referred to as an SS/PBCH block, an SS block (SSB), or the like. It is noted that, the SS, the SSB, or the like may also be referred to as a reference signal.

Furthermore, in the radio communication system 1, a measurement reference signal (sounding reference signal (SRS)), a demodulation reference signal (DMRS), or the like may be transmitted as an uplink reference signal (UL-RS). It is noted that, the DMRSs may be referred to as “user terminal-specific reference signals (UE-specific reference signals)”.

### (Base Station)

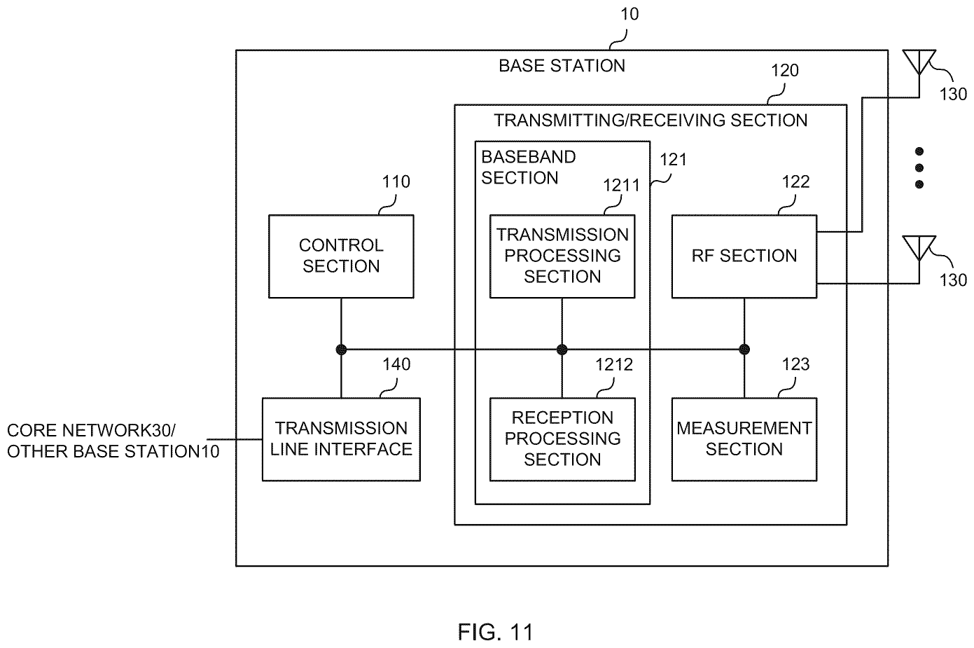

FIG. 11 is a diagram illustrating an example of a configuration of the base station according to one embodiment. The base station 10 includes a control section 110, a transmitting/receiving section 120, a transmitting/receiving antenna 130, and a transmission line interface 140. It is noted that one or more of the control sections 110, one or more of the transmitting/receiving sections 120, one or more of the transmitting/receiving antennas 130, and one or more of the transmission line interfaces 140 may be included.

It is noted that this example mainly describes a functional block which is a characteristic part of the present embodiment, and it may be assumed that the base station 10 also has another functional block necessary for radio communication. A part of processing of each section described below may be omitted.

The control section 110 controls the entire base station 10. The control section 110 can be constituted by a controller, a control circuit, or the like, which is described based on common recognition in the technical field to which the present disclosure relates.

The control section 110 may control signal generation, scheduling (for example, resource allocation or mapping), and the like. The control section 110 may control transmission/reception, measurement, and the like using the transmitting/receiving section 120, the transmitting/receiving antenna 130, and the transmission line interface 140. The control section 110 may generate data to be transmitted as a signal, control information, a sequence, and the like, and may forward the data, the control information, the sequence, and the like to the transmitting/receiving section 120. The control section 110 may perform call processing (such as configuration or releasing) of a communication channel, management of the state of the base station 10, and management of a radio resource.

The transmitting/receiving section 120 may include a baseband section 121, a radio frequency (RF) section 122, and a measurement section 123. The baseband section 121 may include a transmission processing section 1211 and a reception processing section 1212. The transmitting/receiving section 120 can be constituted by a transmitter/receiver, an RF circuit, a baseband circuit, a filter, a phase shifter, a measurement circuit, a transmission/reception circuit, and the like, which are described based on common recognition in the technical field to which the present disclosure relates.

The transmitting/receiving section 120 may be constituted as an integrated transmitting/receiving section, or may be constituted by a transmitting section and a receiving section. The transmitting section may include the transmission processing section 1211 and the RF section 122. The receiving section may be constituted by the reception processing section 1212, the RF section 122, and the measurement section 123.

The transmitting/receiving antenna 130 can be constituted by an antenna described based on common recognition in the technical field to which the present disclosure relates, for example, an array antenna.

The transmitting/receiving section 120 may transmit the above-described downlink channel, synchronization signal, downlink reference signal, and the like. The transmitting/receiving section 120 may receive the above-described uplink channel, uplink reference signal, and the like.

The transmitting/receiving section 120 may form at least one of a Tx beam or a reception beam using digital beam forming (for example, precoding), analog beam forming (for example, phase rotation), and the like.

The transmitting/receiving section 120 (transmission processing section 1211) may perform packet data convergence protocol (PDCP) layer processing, radio link control (RLC) layer processing (for example, RLC retransmission control), medium access control (MAC) layer processing (for example, HARQ retransmission control), and the like on, for example, data, control information, and the like acquired from the control section 110, to generate a bit string to be transmitted.

The transmitting/receiving section 120 (transmission processing section 1211) may perform transmission processing such as channel encoding (which may include error correction encoding), modulation, mapping, filtering processing, discrete Fourier transform (DFT) processing (if necessary), inverse fast Fourier transform (IFFT) processing, precoding, or digital-analog conversion on the bit string to be transmitted, to output a baseband signal.

The transmitting/receiving section 120 (RF section 122) may perform modulation to a radio frequency band, filtering processing, amplification, and the like on the baseband signal, and may transmit a signal in the radio frequency band via the transmitting/receiving antenna 130.

Meanwhile, the transmitting/receiving section 120 (RF section 122) may perform amplification, filtering processing, demodulation to a baseband signal, and the like on the signal in the radio frequency band received by the transmitting/receiving antenna 130.

The transmitting/receiving section 120 (reception processing section 1212) may apply reception processing such as analog-digital conversion, fast Fourier transform (FFT) processing, inverse discrete Fourier transform (IDFT) processing (if necessary), filtering processing, demapping, demodulation, decoding (which may include error correction decoding), MAC layer processing, RLC layer processing, or PDCP layer processing on the acquired baseband signal, to acquire user data and the like.

The transmitting/receiving section 120 (measurement section 123) may perform measurement on the received signal. For example, the measurement section 123 may perform radio resource management (RRM) measurement, channel state information (CSI) measurement, and the like based on the received signal. The measurement section 123 may measure received power (for example, reference signal received power (RSRP)), received quality (for example, reference signal received quality (RSRQ), a signal to interference plus noise ratio (SINR), a signal to noise ratio (SNR)), signal strength (for example, received signal strength indicator (RSSI)), propagation path information (for example, CSI), and the like. A measurement result may be output to the control section 110.

The transmission line interface 140 may transmit/receive a signal (backhaul signaling) to and from an apparatus included in the core network 30, another base stations 10, and the like, and may acquire, transmit, and the like user data (user plane data), control plane data, and the like for the user terminal 20.

It is noted that, the transmitting section and the receiving section of the base station 10 in the present disclosure may include at least one of the transmitting/receiving section 120, the transmitting/receiving antenna 130, and the transmission line interface 140.

The transmitting/receiving section 120 may transmit a configuration of a sounding reference signal (SRS) resource set on a second cell and transmit downlink control information indicating triggering of the SRS resource set in a first cell. The control section 110 may determine a reception timing of the SRS based on the SRS resource set based on the SRS resource set and the downlink control information.

### (User Terminal)

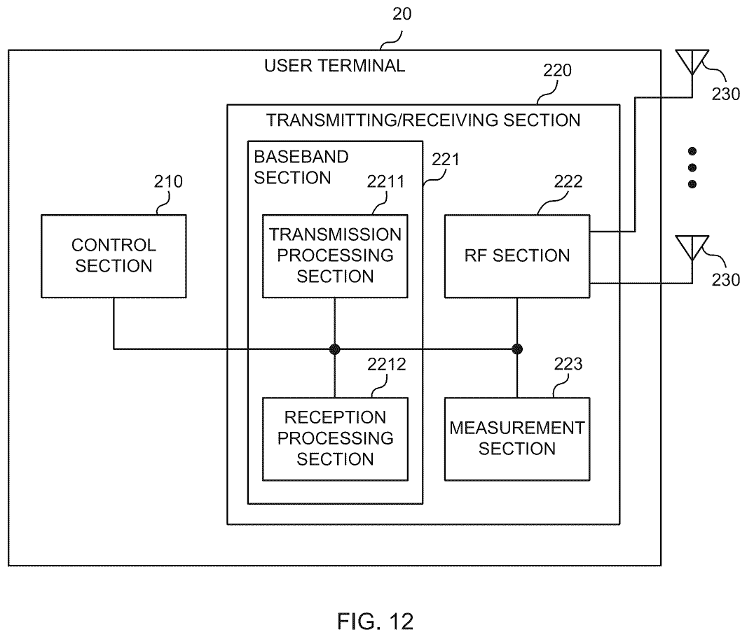

FIG. 12 is a diagram illustrating an example of a configuration of the user terminal according to one embodiment. The user terminal 20 includes a control section 210, a transmitting/receiving section 220, and a transmitting/receiving antenna 230. It is noted that one or more of the control sections 210, one or more of the transmitting/receiving sections 220, and one or more of the transmitting/receiving antennas 230 may be included.

It is noted that, although this example mainly describes functional blocks of a characteristic part of the present embodiment, it may be assumed that the user terminal 20 includes other functional blocks that are necessary for radio communication as well. A part of processing of each section described below may be omitted.

The control section 210 controls the entire user terminal 20. The control section 210 can include a controller, a control circuit, and the like that are described based on common recognition in the technical field related to the present disclosure.

The control section 210 may control signal generation, mapping, and the like. The control section 210 may control transmission/reception, measurement, and the like using the transmitting/receiving section 220 and the transmitting/receiving antenna 230. The control section 210 may generate data to be transmitted as a signal, control information, a sequence, and the like, and may transfer the data, the control information, the sequence, and the like to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can include a transmitter/receiver, an RF circuit, a baseband circuit, a filter, a phase shifter, a measurement circuit, a transmission/reception circuit, and the like that are described based on common recognition in the technical field related to the present disclosure.

The transmitting/receiving section 220 may be formed as an integrated transmitting/receiving section, or may include a transmitting section and a receiving section. The transmitting section may include the transmission processing section 2211 and the RF section 222. The receiving section may be configured by the reception processing section 2212, the RF section 222, and the measurement section 223.

The transmitting/receiving antenna 230 can include an antenna that is described based on common recognition in the technical field related to the present disclosure, for example, an array antenna or the like.

The transmitting/receiving section 220 may receive the above-described downlink channel, synchronization signal, downlink reference signal, and the like. The transmitting/receiving section 220 may transmit the above-described uplink channel, uplink reference signal, and the like.

The transmitting/receiving section 220 may form at least one of a Tx beam and a reception beam by using digital beam forming (for example, precoding), analog beam forming (for example, phase rotation), and the like.

The transmitting/receiving section 220 (transmission processing section 2211) may perform PDCP layer processing, RLC layer processing (for example, RLC retransmission control), MAC layer processing (for example, HARQ retransmission control), and the like, for example, on data, control information, and the like acquired from the control section 210, to generate a bit string to be transmitted.

The transmitting/receiving section 220 (transmission processing section 2211) may perform transmission processing such as channel encoding (which may include error correction encoding), modulation, mapping, filtering processing, DFT processing (if necessary), IFFT processing, precoding, or digital-analog conversion on the bit string to be transmitted, to output a baseband signal.

It is noted that whether to apply DFT processing may be determined based on configuration of transform precoding. In a case where transform precoding is enabled for a certain channel (for example, PUSCH), the transmitting/receiving section 220 (transmission processing section 2211) may perform DFT processing as the transmission processing in order to transmit the channel using a DFT-s-OFDM waveform, and otherwise, DFT processing need not be performed as the transmission processing.

The transmitting/receiving section 220 (RF section 222) may perform modulation to a radio frequency band, filtering processing, amplification, and the like on the baseband signal, to transmit a signal in the radio frequency band via the transmitting/receiving antenna 230.

Meanwhile, the transmitting/receiving section 220 (RF section 222) may perform amplification, filtering processing, demodulation to a baseband signal, and the like on the signal in the radio frequency band received by the transmitting/receiving antenna 230.

The transmitting/receiving section 220 (reception processing section 2212) may apply reception processing such as analog-digital conversion, FFT processing, IDFT processing (if necessary), filtering processing, demapping, demodulation, decoding (which may include error correction decoding), MAC layer processing, RLC layer processing, or PDCP layer processing on the acquired baseband signal to acquire user data and the like.

The transmitting/receiving section 220 (measurement section 223) may perform measurement on the received signal. For example, the measurement section 223 may perform RRM measurement, CSI measurement, and the like based on the received signal. The measurement section 223 may measure received power (for example, RSRP), received quality (for example, RSRQ, SINR, or SNR), signal strength (for example, RSSI), propagation path information (for example, CSI), and the like. A measurement result may be output to the control section 210.

It is noted that the transmitting section and the receiving section of the user terminal 20 in the present disclosure may include at least one of the transmitting/receiving section 220 and the transmitting/receiving antenna 230.

The transmitting/receiving section 220 may receive the configuration of the sounding reference signal (SRS) resource set on the second cell and receive the downlink control information indicating triggering of the SRS resource set in the first cell. The control section 210 may determine a transmission timing of the SRS based on the SRS resource set based on the SRS resource set and the downlink control information.

The SRS resource set may include one or more values related to the timing, the downlink control information may include a field instructing one value of the one or more values, and the control section 210 may determine the timing based on the one value.

The size of the field may be based on the maximum value of the number of one or more values for the timing in a particular bandwidth part (BWP) or each SRS resource set in a particular cell.

One or more values related to the timing may be configured in a specific BWP or a specific cell.

### (Hardware Configuration)

It is noted that the block diagrams that have been used to describe the above embodiments illustrate blocks in functional units. These functional blocks (components) are implemented in arbitrary combinations of at least one of hardware and software. Further, the method of implementing each functional block is not particularly limited. That is, each functional block may be implemented by a single apparatus physically or logically aggregated, or may be implemented by directly or indirectly connecting two or more physically or logically separate apparatuses (in a wired manner, a radio manner, or the like, for example) and using these apparatuses. The functional blocks may be implemented by combining software with the above-described single apparatus or the above-described plurality of apparatuses.

Here, the function includes, but is not limited to, determining, judging, calculating, computing, processing, deriving, investigating, searching, ascertaining, receiving, transmitting, outputting, accessing, solving, selecting, choosing, establishing, comparing, assuming, expecting, regarding, broadcasting, notifying, communicating, forwarding, configuring, reconfiguring, allocating, mapping, assigning, and the like. For example, a functional block (component) that has a transmission function may be referred to as a transmitting section (transmitting unit), a transmitter, and the like. In any case, as described above, the implementation method is not particularly limited.

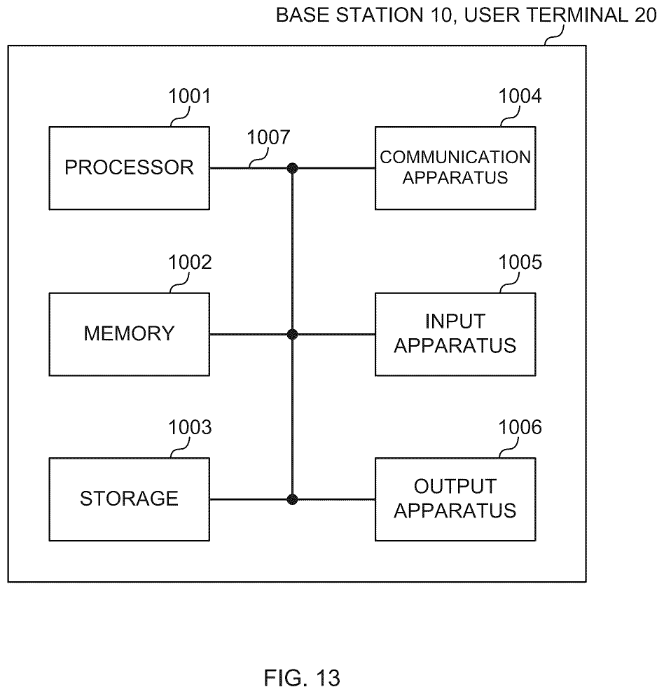

For example, the base station, the user terminal, and the like according to one embodiment of the present disclosure may function as a computer that executes the processing of the radio communication method of the present disclosure. FIG. 13 is a diagram illustrating an example of a hardware configuration of the base station and the user terminal according to one embodiment. Physically, the above-described base station 10 and user terminal 20 may be formed as a computer apparatus that includes a processor 1001, a memory 1002, a storage 1003, a communication apparatus 1004, an input apparatus 1005, an output apparatus 1006, a bus 1007, and the like.

It is noted that in the present disclosure, the terms such as an apparatus, a circuit, a device, a section, and a unit can be interchangeable with each other. The hardware configuration of the base station 10 and the user terminal 20 may be designed to include one or more of the apparatuses illustrated in the drawings, or may be designed not to include some apparatuses.

For example, although only one processor 1001 is illustrated, a plurality of processors may be included. Further, the processing may be executed by one processor, or the processing may be executed by two or more processors simultaneously or sequentially, or using other methods. It is noted that the processor 1001 may be implemented by one or more chips.

Each function of the base station 10 and the user terminal 20 is implemented by given software (program) being read on hardware such as the processor 1001 and the memory 1002, by which the processor 1001 performs operations, controlling communication via the communication apparatus 1004, and controlling at least one of reading and writing of data at the memory 1002 and the storage 1003.

The processor 1001 controls the entire computer by, for example, operating an operating system. The processor 1001 may be implemented by a central processing unit (CPU) including an interface with peripheral equipment, a control apparatus, an operation apparatus, a register, and the like. For example, at least a part of the above-described control section 110 (210), transmitting/receiving section 120 (220), and the like may be implemented by the processor 1001.

The processor 1001 reads programs (program codes), software modules, data, and the like from at least one of the storage 1003 and the communication apparatus 1004 into the memory 1002, and performs various types of processing according to these. As the program, a program that causes a computer to execute at least a part of the operations described in the above-described embodiment is used. For example, the control section 110 (210) may be implemented by control programs that are stored in the memory 1002 and that operate on the processor 1001, and other functional blocks may be implemented likewise.

The memory 1002 is a computer-readable recording medium, and may include, for example, at least one of a read only memory (ROM), an erasable programmable ROM (EPROM), an electrically EPROM (EEPROM), a random access memory (RAM), and other appropriate storage media. The memory 1002 may be referred to as a register, a cache, a main memory (primary storage apparatus), and the like. The memory 1002 can store programs (program codes), software modules, and the like that are executable for implementing the radio communication method according to one embodiment of the present disclosure.

The storage 1003 is a computer-readable recording medium, and may include, for example, at least one of a flexible disk, a floppy (registered trademark) disk, a magneto-optical disk (for example, a compact disc ROM (CD-ROM) and the like), a digital versatile disk, a Blu-ray (registered trademark) disk), a removable disk, a hard disk drive, a smart card, a flash memory device (for example, a card, a stick, or a key drive), a magnetic stripe, a database, a server, and other appropriate storage media. The storage 1003 may be referred to as a “secondary storage apparatus”.

The communication apparatus 1004 is hardware (transmission/reception device) for performing inter-computer communication via at least one of a wired network and a wireless network, and is referred to as, for example, a network device, a network controller, a network card, a communication module, and the like. The communication apparatus 1004 may include a high frequency switch, a duplexer, a filter, a frequency synthesizer, and the like in order to implement, for example, at least one of frequency division duplex (FDD) and time division duplex (TDD). For example, the transmitting/receiving section 120 (220), the transmitting/receiving antenna 130 (230), and the like described above may be implemented by the communication apparatus 1004. The transmitting/receiving section 120 (220) may be implemented by physically or logically separating the transmitting section 120a (220a) and the receiving section 120b (220b) from each other.

The input apparatus 1005 is an input device for receiving input from the outside (for example, a keyboard, a mouse, a microphone, a switch, a button, a sensor, and the like). The output apparatus 1006 is an output device that performs output to the outside (for example, a display, a speaker, a light emitting diode (LED) lamp, or the like). It is noted that the input apparatus 1005 and the output apparatus 1006 may be an integrated configuration (for example, touch panel).

The apparatuses such as the processor 1001 and the memory 1002 are connected by the bus 1007 for communicating information. The bus 1007 may be formed using a single bus, or may be formed using different buses for each apparatus.

Further, the base station 10 and the user terminal 20 may include hardware such as a microprocessor, a digital signal processor (DSP), an application specific integrated circuit (ASIC), a programmable logic device (PLD), or a field programmable gate array (FPGA), and some or all of the functional blocks may be implemented by using the hardware. For example, the processor 1001 may be implemented using at least one of these pieces of hardware.

### (Modifications)

It is noted that terms described in the present disclosure and terms necessary for understanding the present disclosure may be replaced with terms that have the same or similar meanings. For example, a channel, a symbol, and a signal (signal or signaling) may be interchangeable with one another. Further, the signal may be a message. The reference signal can be abbreviated as an RS, and may be referred to as a pilot, a pilot signal, and the like, depending on which standard applies. Further, a component carrier (CC) may be referred to as a cell, a frequency carrier, a carrier frequency, and the like.

A radio frame may include one or more periods (frames) in the time domain. Each of the one or more periods (frames) included in the radio frame may be referred to as a subframe. Further, the subframe may include one or more slots in the time domain. The subframe may be a fixed time duration (for example, 1 ms) that is not dependent on numerology.

Here, the numerology may be a communication parameter used for at least one of transmission and reception of a certain signal or channel. For example, the numerology may indicate at least one of subcarrier spacing (SCS), a bandwidth, a symbol length, a cyclic prefix length, a transmission time interval (TTI), the number of symbols per TTI, a radio frame configuration, specific filtering processing performed by a transceiver in the frequency domain, and specific windowing processing performed by a transceiver in the time domain.

The slot may include one or more symbols in the time domain (orthogonal frequency division multiplexing (OFDM) symbols, single carrier frequency division multiple access (SC-FDMA) symbols, and the like). Also, the slot may be a time unit based on numerology.

The slot may include a plurality of mini slots. Each mini slot may include one or more symbols in the time domain. Further, the mini slot may be referred to as a sub-slot. Each mini slot may include fewer symbols than the slot. A PDSCH (or PUSCH) transmitted in a time unit larger than the mini slot may be referred to as “PDSCH (PUSCH) mapping type A”. A PDSCH (or a PUSCH) transmitted using a mini slot may be referred to as PDSCH (PUSCH) mapping type B.

A radio frame, a subframe, a slot, a mini slot, and a symbol each represent a time unit in signal transmission. The radio frame, the subframe, the slot, the mini slot, and the symbol may be called by other applicable names, respectively. It is noted that time units such as a frame, a subframe, a slot, a mini slot, and a symbol in the present disclosure may be interchangeable with each other.

For example, one subframe may be referred to as TTI, a plurality of consecutive subframes may be referred to as TTI, or one slot or one mini slot may be referred to as TTI. That is, at least one of the subframe and the TTI may be a subframe (1 ms) in the existing LTE, may be a period shorter than 1 ms (for example, one to thirteen symbols), or may be a period longer than 1 ms. It is noted that a unit representing a TTI may be referred to as a slot, a mini slot, or the like instead of a subframe.

Here, a TTI refers to, for example, a minimum time unit of scheduling in radio communication. For example, in the LTE system, a base station performs scheduling to allocate radio resources (a frequency bandwidth, transmit power, and the like that can be used in each user terminal) to each user terminal in TTI units. It is noted that the definition of a TTI is not limited to this.

A TTI may be a transmission time unit of a channel-coded data packet (transport block), a code block, a codeword, and the like or may be a processing unit of scheduling, link adaptation, and the like It is noted that, when a TTI is given, a time interval (for example, the number of symbols) to which a transport block, a code block, a codeword, or the like is actually mapped may be shorter than the TTI.

It is noted that, when one slot or one mini slot is referred to as a TTI, one or more TTIs (that is, one or more slots or one or more mini slots) may be a minimum time unit of scheduling. The number of slots (the number of mini slots) constituting the minimum time unit of scheduling may be controlled.

A TTI having a time duration of 1 ms may be referred to as a usual TTI (TTI in 3GPP Rel. 8 to 12), a normal TTI, a long TTI, a usual subframe, a normal subframe, a long subframe, a slot, or the like. A TTI that is shorter than the usual TTI may be referred to as a shortened TTI, a short TTI, a partial TTI (or fractional TTI), a shortened subframe, a short subframe, a mini slot, a subslot, a slot, or the like.

It is noted that, a long TTI (such as a usual TTI or a subframe) may be replaced with a TTI having a time duration exceeding 1 ms. A short TTI (such as a shortened TTI) may be replaced with a TTI having a TTI length less than the TTI length of a long TTI and more than or equal to 1 ms.

A resource block (RB) is the unit of resource allocation in the time domain and the frequency domain, and may include one or more contiguous subcarriers in the frequency domain. The number of subcarriers included in the RB may be the same regardless of the numerology, and may be twelve, for example. The number of subcarriers included in an RB may be determined based on a numerology.

An RB may include one or more symbols in the time domain, and may have a length of one slot, one mini slot, one subframe, or one TTI. One TTI, one subframe, and the like may each include one or more resource blocks.

It is noted that one or more RBs may be referred to as a physical resource block (PRB), a subcarrier group (SCG), a resource element group (REG), a PRB pair, an RB pair, and the like.

Furthermore, a resource block may include one or more resource elements (REs). For example, one RE may be a radio resource domain of one subcarrier and one symbol.

A bandwidth part (BWP) (which may be referred to as a partial bandwidth or the like) may represent a subset of contiguous common resource blocks (RBs) for a certain numerology in a certain carrier. Here, the common RB may be specified by the index of the RB based on a common reference point of the carrier. PRBs may be defined in a BWP and numbered within the BWP.

The BWP may include a BWP for UL (UL BWP) and a BWP for DL (DL BWP). For the UE, one or more BWPs may be configured within one carrier.

At least one of the configured BWPs may be active, and the UE does not have to assume transmission/reception of a given signal/channel outside the active BWP. It is noted that a “cell”, a “carrier”, and the like in the present disclosure may be interchangeable with “BWP”.

It is noted that the structures of radio frames, subframes, slots, mini slots, symbols, and the like described above are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, the symbol length, the length of cyclic prefix (CP), and the like can be variously changed.

The information, parameters, and the like described in the present disclosure may be represented using absolute values, or may be represented using relative values with respect to given values, or may be represented using other corresponding information. For example, a radio resource may be instructed by a given index.

The names used for parameters and the like in the present disclosure are in no respect limiting. Further, any mathematical expression or the like that uses these parameters may differ from those explicitly disclosed in the present disclosure. Since various channels (PUCCH, PDCCH, and the like) and information elements can be identified by any suitable names, various names allocated to these various channels and information elements are not restrictive names in any respect.

The information, signals, and the like described in the present disclosure may be represented using any of a variety of different technologies. For example, data, an instruction, a command, information, a signal, a bit, a symbol, a chip, and the like, which may be referred to throughout the above description, may be represented by a voltage, a current, an electromagnetic wave, a magnetic field or a magnetic particle, an optical field or an optical photon, or any combination of these.

Information, signals, and the like can be output in at least one of a direction from a higher layer to a lower layer or a direction from a lower layer to a higher layer. Information, signals, and the like may be input and output via a plurality of network nodes.

Input and output information, signals, and the like may be stored in a specific location (for example, memory), or may be managed using a measurement table. The input/output information, signals, and the like can be overwritten, updated, or appended. The output information, signals, and the like may be deleted. Information, signals, and the like that have been input may be transmitted to another apparatus.

Notification of information may be performed not only by using the aspects/embodiments described in the present disclosure but also using another method. For example, the notification of information in the present disclosure may be performed by using physical layer signaling (for example, downlink control information (DCI) or uplink control information (UCI)), higher layer signaling (for example, radio resource control (RRC) signaling, broadcast information (master information block (MIB)), system information block (SIB), or the like), or medium access control (MAC) signaling), another signal, or a combination thereof.

It is noted that the physical layer signaling may be referred to as Layer 1/Layer 2 (L1/L2) control information (L1/L2 control signal), L1 control information (L1 control signal), and the like. Further, the RRC signaling may be referred to as an RRC message, and may be, for example, an RRC Connection Setup message, an RRC Connection Reconfiguration message, and the like. Further, notification of the MAC signaling may be performed using, for example, a MAC control element (CE).

Also, notification of given information (for example, notification of information to the effect that “X holds”) does not necessarily have to be sent explicitly, and can be sent implicitly (for example, by not notifying this given information, by reporting another piece of information, and the like).

Determination may be performed using a value represented by one bit (0 or 1), or may be performed using a Boolean represented by true or false, or may be performed by comparing numerical values (for example, comparison with a given value).

Software, regardless of whether it is referred to as software, firmware, middleware, microcode, or a hardware description language, or referred to by another name, should be interpreted broadly to mean an instruction, an instruction set, a code, a code segment, a program code, a program, a subprogram, a software module, an application, a software application, a software package, a routine, a subroutine, an object, an executable file, an execution thread, a procedure, a function, and the like.

Moreover, software, instructions, information, and the like may be transmitted and received via communication media. For example, when software is transmitted from a website, a server, or another remote source by using at least one of a wired technology (coaxial cable, optical fiber cable, twisted pair, digital subscriber line (DSL), or the like) and a wireless technology (infrared rays, microwaves, and the like), at least one of the wired technology and the wireless technology is included within the definition of a transmission medium.

The terms “system” and “network” used in the present disclosure may be used interchangeably. The “network” may mean an apparatus (for example, a base station) included in the network.

In the present disclosure, terms such as “precoding”, “precoder”, “weight (precoding weight)”, “quasi-co-location (QCL)”, “transmission configuration indication state (TCI state)”, “spatial relation”, “spatial domain filter”, “transmit power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” can be used interchangeably.

In the present disclosure, terms such as “base station (BS)”, “radio base station”, “fixed station”, “NodeB”, “eNodeB (eNB)”, “gNodeB (gNB)”, “access point”, “transmission point (TP)”, “reception point (RP)”, “transmission/reception point (TRP)”, “panel”, “cell”, “sector”, “cell group”, “carrier”, and “component carrier”, can be used interchangeably. The base station may be referred to as a term such as a macro cell, a small cell, a femto cell, or a pico cell.

The base station can accommodate one or more (for example, three) cells. In a case where the base station accommodates a plurality of cells, the entire coverage area of the base station can be partitioned into a plurality of smaller areas, and each smaller area can provide communication services through a base station subsystem (for example, small base station for indoors (remote radio head (RRH))). The term “cell” or “sector” refers to a part or the whole of a coverage area of at least one of the base station and the base station subsystem that performs a communication service in this coverage.

In the present disclosure, the terms such as “mobile station (MS)”, “user terminal”, “user equipment (UE)”, and “terminal” can be used interchangeably.

The mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms.

At least one of the base station and the mobile station may be referred to as a transmission apparatus, a reception apparatus, a radio communication apparatus, and the like. It is noted that at least one of the base station or the mobile station may be a device mounted on a moving body (moving object), a moving body itself, and the like.

The moving body refers to a movable object, the moving speed is arbitrary, and naturally includes a case in which the moving body is stopped. The moving body includes, for example, a vehicle, a transport vehicle, an automobile, a motorcycle, a bicycle, a connected car, an excavator, a bulldozer, a wheel loader, a dump truck, a forklift, a train, a bus, a rear car, a human-powered vehicle, a ship and other watercraft, an airplane, a rocket, an artificial satellite, a drone, a multicopter, a quadcopter, a balloon, and objects mounted thereon, and is not limited thereto. Further, the moving body may be a moving body that autonomously travels based on an operation command.

The moving body may be a transportation (for example, a car, an airplane, or the like), an unmanned moving body (for example, a drone, an autonomous car, or the like), or a (manned or unmanned) robot. It is noted that at least one of the base station and the mobile station also includes an apparatus that does not necessarily move during a communication operation. For example, at least one of the base station and the mobile station may be an Internet of Things (IoT) device such as a sensor.

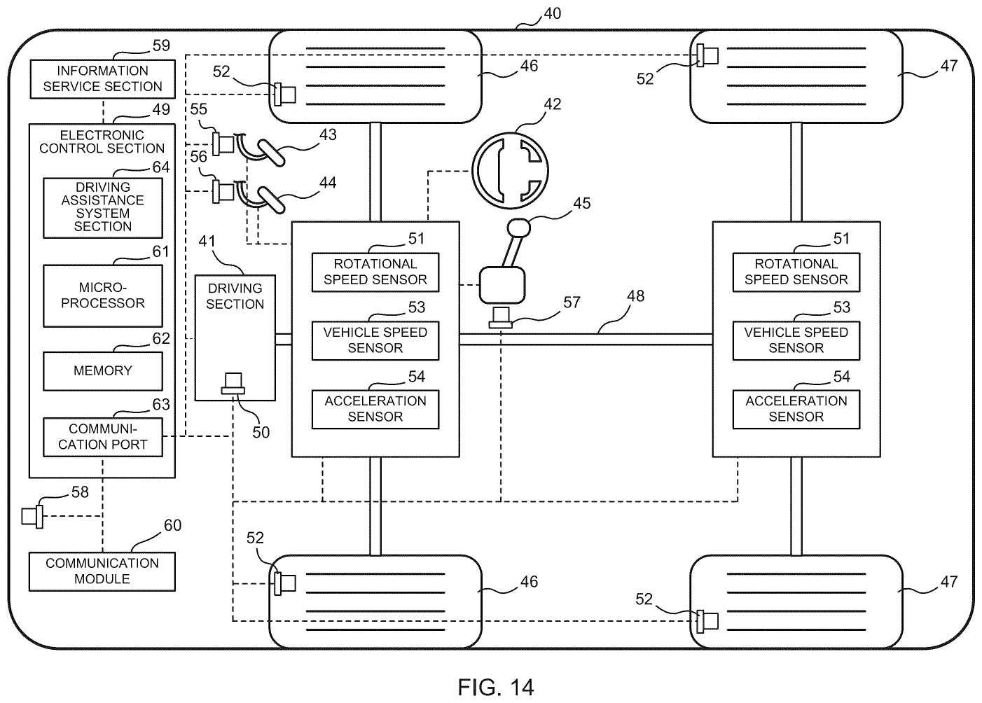

FIG. 14 is a diagram illustrating an example of a vehicle according to one embodiment. A vehicle 40 includes a drive unit 41, a steering unit 42, an accelerator pedal 43, a brake pedal 44, a shift lever 45, left and right front wheels 46, left and right rear wheels 47, an axle 48, an electronic control unit 49, various sensors (includes a current sensor 50, a rotation speed sensor 51, an air pressure sensor 52, a vehicle speed sensor 53, an acceleration sensor 54, an accelerator pedal sensor 55, a brake pedal sensor 56, a shift lever sensor 57, and an object detection sensor 58), an information service unit 59, and a communication module 60.

The drive unit 41 includes, for example, at least one of an engine, a motor, and a hybrid of an engine and a motor. The steering unit 42 includes at least a steering wheel (also referred to as a handle), and is configured to steer at least one of the front wheel 46 and the rear wheel 47 based on the operation of the steering wheel operated by a user.

The electronic control unit 49 includes a microprocessor 61, a memory (ROM, RAM) 62, and a communication port (for example, an input/output (IO) port) 63. Signals from the various sensors 50 to 58 provided in the vehicle are input to the electronic control unit 49. The electronic control unit 49 may be referred to as an electronic control unit (ECU).

The signals from the various sensors 50 to 58 include a current signal from the current sensor 50 that senses the current of the motor, a rotation speed signal of the front wheel 46/the rear wheel 47 acquired by the rotation speed sensor 51, an air pressure signal of the front wheel 46/the rear wheel 47 acquired by the air pressure sensor 52, a vehicle speed signal acquired by the vehicle speed sensor 53, an acceleration signal acquired by the acceleration sensor 54, a depression amount signal of the accelerator pedal 43 acquired by the accelerator pedal sensor 55, a depression amount signal of the brake pedal 44 acquired by the brake pedal sensor 56, an operation signal of the shift lever 45 acquired by the shift lever sensor 57, a detection signal for detecting an obstacle, a vehicle, a pedestrian, and the like acquired by the object detection sensor 58, and the like.

The information service unit 59 includes various devices for providing (outputting) various types of information such as driving information, traffic information, and entertainment information, such as a car navigation system, an audio system, a speaker, a display, a television, and a radio, and one or more ECUs that control these devices. The information service unit 59 provides various types of information/services (for example, multimedia information/multimedia services) to an occupant of the vehicle 40 using information acquired from an external device via the communication module 60 or the like.

The information service unit 59 may include an input device (for example, a keyboard, a mouse, a microphone, a switch, a button, a sensor, a touch panel, or the like) that receives an input from the outside, or may include an output device (for example, a display, a speaker, an LED lamp, a touch panel, or the like) that performs an output to the outside.

A driving assistance system unit 64 includes various devices for providing functions for preventing an accident in advance and reducing a driving load of a driver, such as a millimeter wave radar, light detection and ranging (LiDAR), a camera, a positioning locator (for example, global navigation satellite system (GNSS) or the like), map information (for example, a high definition (HD) map, an autonomous vehicle (AV) map, and the like), a gyro system (for example, an inertial measurement unit (IMU), an inertial navigation system (INS), or the like), an artificial intelligence (AI) chip, and an AI processor, and one or more ECUs for controlling these devices. Further, the driving assistance system unit 64 also transmits and receives various types of information via the communication module 60 so as to achieve a driving assistance function or an automatic driving function.

The communication module 60 can communicate with the microprocessor 61 and components of the vehicle 40 via the communication port 63. For example, the communication module 60 transmits and receives data (information) to and from the drive unit 41, the steering unit 42, the accelerator pedal 43, the brake pedal 44, the shift lever 45, the left and right front wheels 46, the left and right rear wheels 47, the axle 48, the microprocessor 61 and the memory (ROM, RAM) 62 in the electronic control unit 49, and the various sensors 50 to 58 provided in the vehicle 40 via the communication port 63.

The communication module 60 is a communication device that can be controlled by the microprocessor 61 of the electronic control unit 49 and can communicate with an external device. For example, various types of information are transmitted and received to and from an external device via radio communication. The communication module 60 may be either inside or outside the electronic control unit 49. The external device may be, for example, the base station 10, the user terminal 20, or the like described above. Furthermore, the communication module 60 may be, for example, at least one of the base station 10 and the user terminal 20 described above (may function as at least one of the base station 10 and the user terminal 20).

The communication module 60 may transmit at least one of the above-described signals from the various sensors 50 to 58 input to the electronic control unit 49, information obtained based on the signals, and information based on an input from the outside (user) obtained via the information service unit 59 to the external device via radio communication. The electronic control unit 49, the various sensors 50 to 58, the information service unit 59, and the like may be referred to as input units that receive inputs. For example, the PUSCH transmitted by the communication module 60 may include information based on the above input.

The communication module 60 receives various types of information (traffic information, traffic signal information, inter-vehicle information, and the like) transmitted from an external device, and displays the information on the information service unit 59 provided in the vehicle. The information service unit 59 may be referred to as an output unit that outputs information (for example, information is output to a device such as a display or a speaker based on a PDSCH (or data/information decoded from the PDSCH) received by the communication module 60).

The communication module 60 also stores various types of information received from external devices in the memory 62 available by the microprocessor 61. Based on the information stored in the memory 62, the microprocessor 61 may control the drive unit 41, the steering unit 42, the accelerator pedal 43, the brake pedal 44, the shift lever 45, the left and right front wheels 46, the left and right rear wheels 47, the axle 48, the various sensors 50 to 58, and the like provided in the vehicle 40.

The base station in the present disclosure may be interchangeable with a user terminal. For example, each aspect/embodiment of the present disclosure may be applied to a configuration in which communication between the base station and the user terminal is replaced with communication among a plurality of user terminals (which may be referred to as, for example, device-to-device (D2D), vehicle-to-everything (V2X), and the like). In this case, the user terminal 20 may have the function of the above-described base station 10. In addition, the terms such as “uplink” and “downlink” may be interchangeable with terms corresponding to terminal-to-terminal communication (for example, “sidelink”). For example, an uplink channel, a downlink channel, and the like may be interchangeable with a sidelink channel.

Similarly, the user terminal in the present disclosure may be replaced with a base station. In the case, the base station 10 may have the function of the above-mentioned user terminal 20.

In the present disclosure, the operation performed by the base station may be performed by an upper node thereof in some cases. In a network including one or a plurality of network nodes with a base station, it is clear that various operations performed for communication with a terminal can be performed by a base station, one or more network nodes (for example, mobility management entity (MME) and serving-gateway (S-GW) are possible, but are not limitations) other than the base station, or a combination thereof.

Each aspect/embodiment described in the present disclosure may be used alone, used in combination, or switched in association with execution. Further, the order of processing procedures, sequences, flowcharts, and the like of the aspects/embodiments described in the present disclosure may be re-ordered as long as there is no inconsistency. For example, for the method described in the present disclosure, various step elements are presented by using an illustrative order, and the method is not limited to the presented specific order.

Each aspect/embodiment described in the present disclosure may be applied to a system using Long-Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG(x is, for example, an integer or decimal)). Future Radio Access (FRA), New-Radio Access Technology (RAT). New Radio (NR), New radio access (NX), Future generation radio access (FX), Global System for Mobile communications (GSM (registered trademark)), CDMA2000, Ultra Mobile Broadband (UMB), IEEE 802.11 (Wi-Fi (registered trademark)), IEEE 802.16 (WIMAX (registered trademark)), IEEE 802.20, Ultra-WideBand (UWB), Bluetooth (registered trademark), or another appropriate radio communication method, a next generation system extended, modified, generated, or prescribed based on those described above, and the like. Further, a plurality of systems may be combined (for example, a combination of LTE or LTE-A and 5G, and the like) and applied.

The phrase “based on” used in the present disclosure does not mean “based only on”, unless otherwise specified. In other words, the phrase “based on” means both “based only on” and “based at least on”.

Any reference to an element using designations such as “first” and “second” used in the present disclosure does not generally limit the amount or order of these elements. These designations can be used in the present disclosure, as a convenient way of distinguishing between two or more elements. In this way, reference to the first and second elements does not imply that only two elements may be employed, or that the first element must precede the second element in some way.

The term “determining” used in the present disclosure may include a wide variety of operations. For example, “determining” may be regarded as “determining” judging, calculating, computing, processing, deriving, investigating, looking up, search, inquiry (for example, looking up in table, database, or another data structure), ascertaining, and the like.

Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on.

In addition, to “judge” and “determine” as used herein may be interpreted to mean making judgements and determinations related to resolving, selecting, choosing, establishing, comparing and so on. In other words, to “judge” and “determine” as used herein may be interpreted to mean making judgements and determinations related to some action.

“Determining” may be interchangeable with “assuming”, “expecting”, “considering”, and the like.

The “maximum transmit power” described in the present disclosure may mean the maximum value of the transmit power, may mean the nominal UE maximum transmit power, or may mean the rated UE maximum transmit power.

The terms “connected” and “coupled” used in the present disclosure, or all variations thereof mean all direct or indirect connections or coupling between two or more elements, and can include the presence of one or more intermediate elements between two elements “connected” or “coupled” with each other. The coupling or connection between the elements may be physical, logical, or a combination of these. For example, the term “connection” is interchangeable with “access”.

In the present disclosure, when two elements are connected, the two elements can be considered to be “connected” or “coupled” with each other by using one or more electrical wires, cables, printed electrical connections, and the like, and using, as some non-limiting and non-inclusive examples, electromagnetic energy and the like having a wavelength in a radio frequency domain, a microwave domain, and an optical (both visible and invisible) domain.

In the present disclosure, the phrase “A and B are different” may mean “A and B are different from each other”. It is noted that the phrase may mean that “A and B are different from C”. The terms such as “leave”, “coupled”, and the like may be interpreted similarly to “different”.

In the present disclosure, when “include”, “including”, and variations thereof are used, these terms are intended to be inclusive similarly to the term “comprising”. The term “or” used in the present disclosure is intended not to be an exclusive-OR.

In the present disclosure, when articles in English such as “a”, “an”, and “the” are added in translation, the present disclosure may include the plural forms of nouns that follow these articles.

Although the invention according to the present disclosure has been described in detail above, it is obvious to a person skilled in the art that the invention according to the present disclosure is by no means limited to the embodiments described in the present disclosure. The invention according to the present disclosure can be embodied with various corrections and in various modified aspects, without departing from the spirit and scope of the invention defined based on the description of claims. Consequently, the description of the present disclosure is provided only for the purpose of explaining examples, and should by no means be construed to limit the invention according to the present disclosure in any way.

The present application is based on Japanese Patent Application No. 2021-184362 filed on Nov. 11, 2021. The contents of the present application are all incorporated herein.

1.-6. (canceled)

7. A terminal comprising:
a receiver that receives radio resource control (RRC) signaling that configures a plurality of sounding reference signal (SRS) resource sets for a second cell, and receives, in a first cell, downlink control information (DCI) including a field indicating one offset value among one or more offset values configured for each of the plurality of SRS resource sets; and
a processor that controls transmission of an SRS based on the field,
wherein a bit size of the field is determined based on a number of offset values configured for an SRS resource set with a largest number of offset values among the plurality of SRS resource sets configured for the second cell.

8. A radio communication method for a terminal, comprising:
receiving radio resource control (RRC) signaling that configures a plurality of sounding reference signal (SRS) resource sets for a second cell, and receiving, in a first cell, downlink control information (DCI) including a field indicating one offset value among one or more offset values configured for each of the plurality of SRS resource sets; and
controlling transmission of an SRS based on the field,
wherein a bit size of the field is determined based on a number of offset values configured for an SRS resource set with a largest number of offset values among the plurality of SRS resource sets configured for the second cell.

9. A base station comprising:
a transmitter that transmits radio resource control (RRC) signaling that configures a plurality of sounding reference signal (SRS) resource sets for a second cell, and transmits, in a first cell, downlink control information (DCI) including a field indicating one offset value among one or more offset values configured for each of the plurality of SRS resource sets;
a receiver that receives an SRS transmitted from a terminal based on the field; and
a processor that determines a bit size of the field, based on a number of offset values configured for an SRS resource set with a largest number of offset values among the plurality of SRS resource sets configured for the second cell.

10. A system comprising a terminal and a base station, wherein
the terminal comprises:
a receiver that receives radio resource control (RRC) signaling that configures a plurality of sounding reference signal (SRS) resource sets for a second cell, and receives, in a first cell, downlink control information (DCI) including a field indicating one offset value among one or more offset values configured for each of the plurality of SRS resource sets; and
a processor that controls transmission of an SRS based on the field, and
the base station comprises:
a receiver that receives the SRS,
wherein a bit size of the field is determined based on a number of offset values configured for an SRS resource set with a largest number of offset values among the plurality of SRS resource sets configured for the second cell.
